(19) United States
(12) Patent Application Publication
(10) Pub. No.: US 2026/0332291 A1
(43) Pub. Date: Oct. 22, 2026

(54) DEPLOYMENT-SPECIFIC PRECODING CODEBOOKS

(71) Applicant: QUALCOMM Incorporated, San Diego, CA (US)

(72) Inventors: Vasanthan RAGHAVAN, West Windsor Township, NJ (US); Juergen CEZANNE, Ocean Township, NJ (US); Junyi LI, Greentown, PA (US)

(21) Appl. No.: 19/180,733

(22) Filed: Apr. 16, 2025

(51) Int. Cl. H04L 1/00; H04B 7/06; H04W 76/20

(52) U.S. Cl. CPC H04L 1/0003; H04B 7/0626; H04B 7/0632; H04B 7/0639; H04W 76/20

(57) ABSTRACT

Certain aspects of the present disclosure provide techniques for wireless communications. An example method includes obtaining, from a network entity, a first message that indicates a location corresponding to a codebook available for download; and communicating with the network entity based on the codebook. Another example method includes sending, to a UE, a first message that indicates a location corresponding to a codebook available for download; and communicating with the UE based on the codebook.

### INTRODUCTION

### Field of the Disclosure

Aspects of the present disclosure relate to wireless communications, and more particularly, to techniques for communicating channel state feedback.

### DESCRIPTION OF RELATED ART

Wireless communications systems are widely deployed to provide various telecommunication services such as telephony, video, data, messaging, broadcasts, or other similar types of services. These wireless communications systems may employ multiple-access technologies capable of supporting communications with multiple users by sharing available wireless communications system resources with those users.

Although wireless communications systems have made great technological advancements over many years, challenges still exist. For example, complex and dynamic environments can still attenuate or block signals between wireless transmitters and wireless receivers. Accordingly, there is a continuous desire to improve the technical performance of wireless communications systems, including, for example: improving speed and data carrying capacity of communications, improving efficiency of the use of shared communications mediums, reducing power used by transmitters and receivers while performing communications, improving reliability of wireless communications, avoiding redundant transmissions and/or receptions and related processing, improving the coverage area of wireless communications, increasing the number and types of devices that can access wireless communications systems, increasing the ability for different types of devices to intercommunicate, increasing the number and type of wireless communications mediums available for use, and the like. Consequently, there exists a need for further improvements in wireless communications systems to overcome the aforementioned technical challenges and others.

### SUMMARY

Certain aspects provide a method for wireless communications by a user equipment (UE). The method includes obtaining, from a network entity, a first message that indicates a location corresponding to a codebook available for download; and communicating with the network entity based on the codebook.

Certain aspects provide a method for wireless communications by a network entity. The method includes sending, to a UE, a first message that indicates a location corresponding to a codebook available for download; and communicating with the UE based on the codebook.

Other aspects provide: one or more apparatuses operable, configured, or otherwise adapted to perform any portion of any method described herein (e.g., such that performance may be by only one apparatus or in a distributed fashion across multiple apparatuses); one or more non-transitory, computer-readable media comprising instructions that, when executed by one or more processors of one or more apparatuses, cause the one or more apparatuses to perform any portion of any method described herein (e.g., such that instructions may be included in only one computer-readable medium or in a distributed fashion across multiple computer-readable media, such that instructions may be executed by only one processor or by multiple processors in a distributed fashion, such that each apparatus of the one or more apparatuses may include one processor or multiple processors, and/or such that performance may be by only one apparatus or in a distributed fashion across multiple apparatuses); one or more computer program products embodied on one or more computer-readable storage media comprising code for performing any portion of any method described herein (e.g., such that code may be stored in only one computer-readable medium or across computer-readable media in a distributed fashion); and/or one or more apparatuses comprising one or more means for performing any portion of any method described herein (e.g., such that performance would be by only one apparatus or by multiple apparatuses in a distributed fashion). By way of example, an apparatus may comprise a processing system, a device with a processing system, or processing systems cooperating over one or more networks. An apparatus may comprise one or more memories; and one or more processors configured to cause the apparatus to perform any portion of any method described herein. In some examples, one or more of the processors may be preconfigured to perform various functions or operations described herein without requiring configuration by software.

The following description and the appended figures set forth certain features for purposes of illustration.

### BRIEF DESCRIPTION OF DRAWINGS

The appended figures depict certain features of the various aspects described herein and are not to be considered limiting of the scope of this disclosure.

FIG. 1 depicts an example wireless communications network.

FIG. 2 depicts an example disaggregated base station architecture.

FIG. 3 depicts aspects of network entities and a user equipment (UE).

FIGS. 4A, 4B, 4C, and 4D depict various example aspects of data structures for a wireless communications network.

FIG. 5 depicts a process flow for closed-loop feedback associated with a communication channel between a network entity and a UE.

FIG. 6 illustrates a matrix notation of an example precoding feedback codebook.

FIG. 7 illustrates an example precoding architecture for communication channels between a network entity and a UE.

FIG. 8 depicts an example wireless communications network.

FIG. 9 depicts a process flow for communications in a network between a network entity and a UE.

FIG. 10 depicts a method for wireless communications.

FIG. 11 depicts another method for wireless communications.

FIG. 12 depicts aspects of an example communications device.

FIG. 13 depicts aspects of an example communications device.

### DETAILED DESCRIPTION

Aspects of the present disclosure provide apparatuses, methods, processing systems, and computer-readable mediums for deployment-specific precoding codebooks for communicating channel state feedback.

A wireless communication system may include a number of devices and network entities employing techniques for exchanging information wirelessly. For example, a wireless communication system may include devices (e.g., user equipments (UEs)) and network entities (e.g., base stations (BSs)) that wirelessly communicate data, control information, reference signals, etc. (e.g., according to various wireless communication system implementations). The wireless communication system may employ various technologies to improve throughput, achieve a high data rate, and/or improve the energy efficiency of the wireless communication system. These technologies may allow a wireless communication system to support communication between an increasing number of devices and network entities, support advanced functionalities at various devices, and improve the quality of communication between devices and network entities.

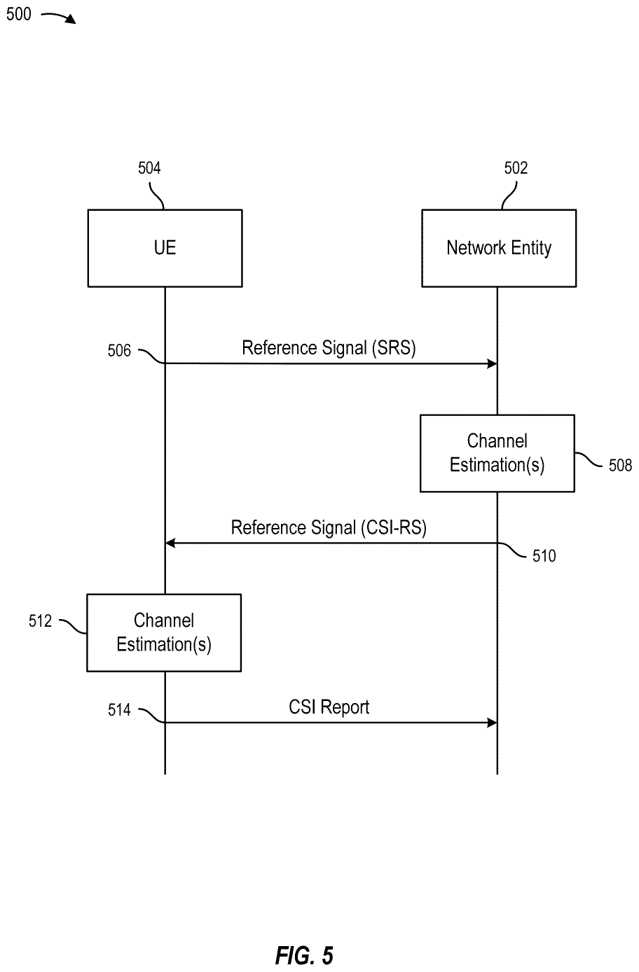

In certain cases, closed-loop feedback associated with a communication channel may be used to dynamically adapt communication parameters (e.g., modulation and coding scheme (MCS), beamforming, multiple-input and multiple-output (MIMO) layers, or the like) according to time varying channel conditions to improve the quality of communication between devices and network entities. For example, the time varying channel conditions may include channel conditions that change due to UE mobility, environment conditions, scattering, fading, interference, noise, or the like. As an example, a UE may monitor certain reference signals transmitted by a network entity (e.g., channel state information (CSI) reference signals (CSI-RSs), synchronization signal blocks (SSBs), etc.) and/or may perform measurements on the reference signals to obtain CSI. Subsequently, the UE may send a CSI report to the network entity, where the CSI report includes the obtained CSI. Subsequently, the network entity may adjust certain communication parameters in response to the CSI report transmitted by the UE. This closed-loop feedback scheme may be referred to as channel state feedback, CSI feedback, and/or CSI reporting. Channel state feedback is described in greater detail with respect to FIG. 5.

In some aspects, the CSI report may indicate channel properties of a communication link between the network entity and the UE. For example, the CSI report may indicate the effect of, for example, scattering, fading, and path loss of a signal propagating across the communication link. In some cases, the CSI report may indicate a preferred precoding of the UE for MIMO and/or beamformed communications, for example, in the form of a precoding feedback (e.g., a precoding matrix indicator (PMI)) as further described herein. As an example, a CSI report may include a channel quality indicator (CQI), PMI, a rank indicator (RI), etc. Additional or other information may be included in a CSI report.

In certain aspects, precoding feedback in a CSI report may be indicated via a precoding codebook. For example, a PMI in a CSI report may indicate one or more indices corresponding to one or more precoding matrices of a precoding codebook that the UE prefers for a network entity to apply to downlink transmissions (e.g., based on reference signal measurements), where the precoding codebook is previously indicated by the network entity via a parameter in a configuration message for the CSI report (e.g., a CodebookConfig parameter in a CSI-ReportConfig message). In some aspects, a precoding codebook may define matrix notations (e.g., matrix indices) for reporting by the UE of a preferred precoding for one or more beams, for example, in the context of gains and phase shifts applied across antenna elements (e.g., of the network entity) that form certain beams. For example, precoding may involve individual control of amplitudes and phases of signals (e.g., according to a precoding matrix) sent from various transmit antennas of the network entity.

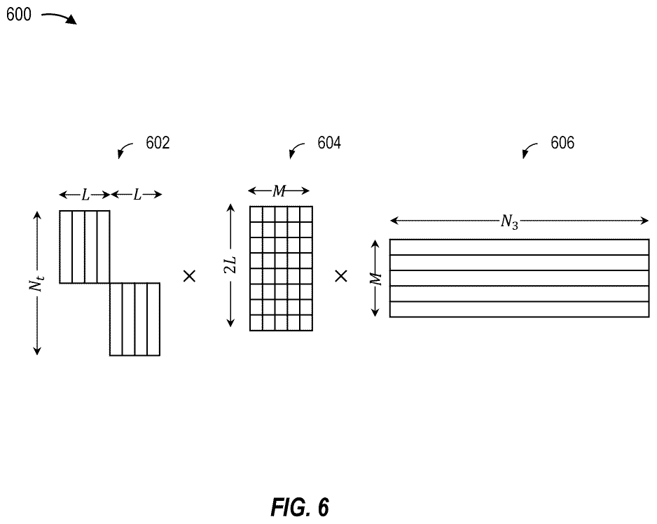

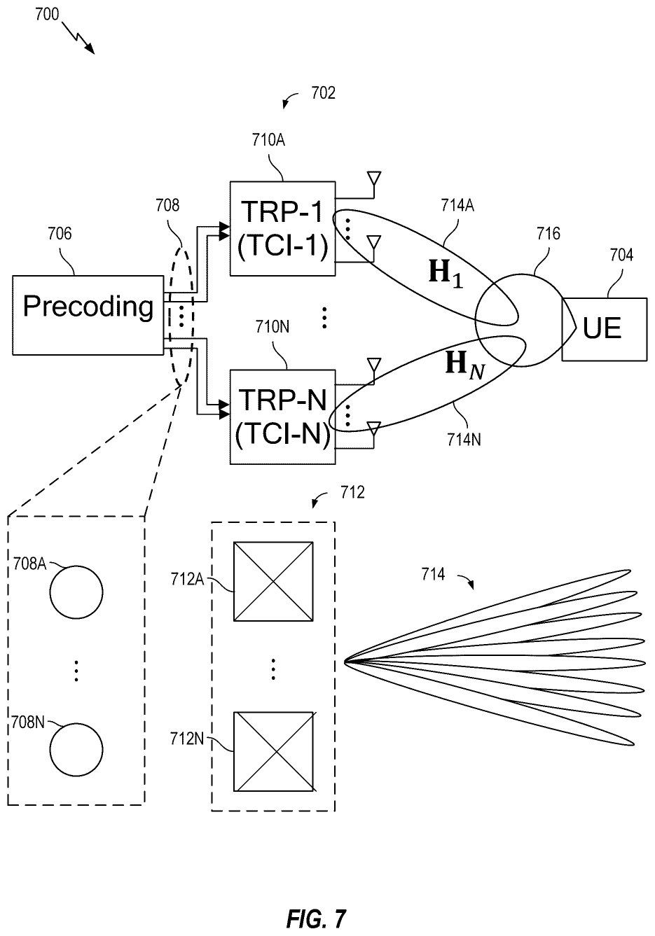

More generally, precoding may include signal processing at a transmitter (e.g., network entity) to improve a quality of a corresponding received signal at specific receivers (e.g., UEs) and receiving antennas while reducing interference to other receivers and receiving antennas, where the signal processing is based on a precoding matrix. That is, precoding may involve preprocessing of a signal to be transmitted according to a precoding matrix of a precoding codebook to improve decoding performance at receiving devices (e.g., based on the improved received signal quality and/or using specific transmit beams of the network entity) and to increase spectral efficiency (e.g., increase how much data can be transmitted over a given bandwidth). In some aspects, a precoding codebook may include one or more precoding matrices (e.g., having complex value elements) that are used to transform data bits (e.g., of a downlink channel) to another set of data bits that map to different antenna ports of the network entity for downlink transmissions. Precoding is described in greater detail with respect to FIGS. 6 and 7.

Technical problems for precoding may include, for example, the corresponding precoding codebooks for the precoding being predefined in wireless communications standards for baseband operations or generalized communications scenarios or environments. In some aspects, precoding codebooks may be specified and/or defined in wireless communications standards for different assumptions of numbers of ports at a network entity and not for specific communication scenarios, such as rural or urban settings, different amounts of users attempting to communicate with a single network entity (e.g., single or multi-user scenarios), different elevation coverages, etc. A UE may determine a precoder (e.g., precoding matrix) from a predefined precoding codebook as described above (e.g., based on measurements of reference signals transmitted by the network entity) and may indicate a PMI, CQI, and RI in a CSI report corresponding to this precoder choice. As such, performance improvements at the network entity or UE may be limited to precoders from the defined precoding codebooks. Subsequently, a gap between optimal performance of downlink transmissions (e.g., using singular value decomposition (SVD) precoders at both the network entity and the UE) and codebook-based performance may be significant depending on a channel structure (e.g., richness of channel, array dimensions, etc.).

Aspects described herein may overcome the aforementioned technical problem(s), for example, by providing deployment-specific precoding codebooks that are defined by a network entity based on an environment in which the network entity is deployed and/or other communication parameters. For example, the network entity may indicate, to one or more UEs (e.g., via a broadcast message), a location that corresponds to a deployment-specific precoding codebook that is available for download. Subsequently, the network entity may communicate with at least one of the UEs based on the deployment-specific precoding codebook. In some aspects, the location may include a public database that stores one or more codebooks (e.g., including the deployment-specific precoding codebook). For example, the location where the codebook is stored may include an online database or a virtual location with an Internet Protocol (IP) address. Additionally, the deployment-specific precoding codebook may include multiple precoders of different ranks and associated modulation and coding schemes (MCSs), and the UE may select a precoder from the multiple precoders and indicate the selected precoder with a corresponding rank and associated MCS to be used with the selected precoder via channel state feedback (e.g., in a CSI report). Accordingly, the network entity and the UE may communicate based on the selected precoder, corresponding rank, and associated MCS.

Certain techniques for using deployment-specific precoding codebooks for communications between a network entity and UE described herein may provide beneficial technical effects and/or advantages. In some aspects, the techniques for using deployment-specific precoding codebooks may enable improved wireless communications performance, such as increased reliability and increased throughput. For example, the deployment-specific precoding codebooks may be defined and used for specific communication scenarios and environments for the network entity (e.g., deployments of the network entity) as opposed to the generic environments for which precoding codebooks are predefined in wireless communications standards. As such, the deployment-specific precoding codebooks may take into consideration the specific communication scenarios and environments for the network entity, thereby increasing reliability and throughput for communications between the network entity and UEs, such as using specific angles and/or coverage regions based on the deployment-specific precoding codebooks to more accurately serve UEs in the specific communication scenarios and environments for the network entity.

### Introduction to Wireless Communications Networks

The techniques and methods described herein may be used for various wireless communications networks. While aspects may be described herein using terminology commonly associated with 3G, 4G, 5G, 6G, and/or other generations of wireless technologies, aspects of the present disclosure may likewise be applicable to other communications systems and standards not explicitly mentioned herein.

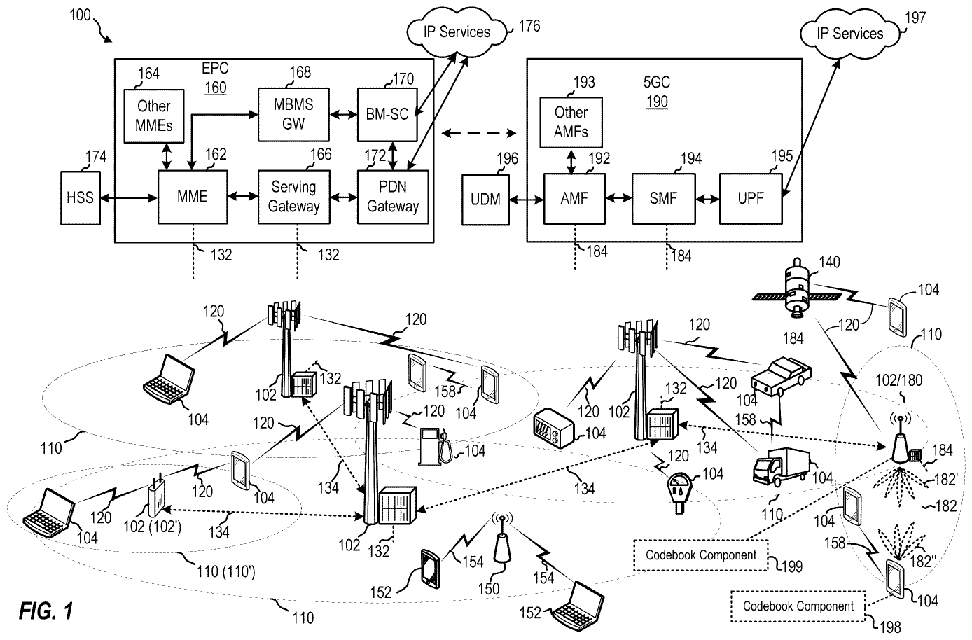

FIG. 1 depicts an example of a wireless communications network 100, in which aspects described herein may be implemented.

Generally, wireless communications network 100 includes various network entities (alternatively, network elements or network nodes). A network entity is generally a communications device and/or a communications function performed by a communications device (e.g., a user equipment (UE), a base station (BS), a component of a BS, a server, etc.). As such communications devices are part of wireless communications network 100, and facilitate wireless communications, such communications devices may be referred to as wireless communications devices. For example, various functions of a network as well as various devices associated with and interacting with a network may be considered network entities. Further, wireless communications network 100 may include terrestrial aspects, such as ground-based network entities (e.g., BSs 102), and non-terrestrial aspects (also referred to herein as non-terrestrial network entities). A non-terrestrial network entity may include satellite 140, which may be an example of an aerial or space-borne platform. In some examples, satellite 140 may include one or more network entities on-board (e.g., one or more BSs) capable of communicating with other network elements (e.g., terrestrial BSs) and UEs. For example, satellite 140 may be implemented according to a regenerative architecture (also referred to as a non-transparent architecture), and a gNB implemented at satellite 140 may implement higher-layer network functions. As another example, satellite 140 may be implemented according to a transparent architecture, and may perform a physical or other lower-layer repeater function for UEs and a network entity (such as a gateway associated with the satellite 140).

In the depicted example, wireless communications network 100 includes BSs 102, UEs 104, and one or more core networks, such as an Evolved Packet Core (EPC) 160 or a 5G Core (5GC) network 190, which interoperate to provide communications services over various communications links, including wired and wireless links. In some aspects, a core network, such as a 6G core, may implement a converged service-based architecture. In a converged service-based architecture, functions traditionally split between a core network (such as 5GC network 190) and a radio access network (RAN) (such as BS 102) may be implemented at a single network entity. For example, a mobility network entity may perform both core network functions and RAN functions related to mobility of UEs 104 attached to the wireless communications network 100. “Network entity” can refer to a BS 102, a network entity of EPC 160 or 5GC network 190, or a network entity of a converged service-based architecture.

FIG. 1 depicts various example UEs 104. UE 104 may include a cellular phone, a smart phone, a session initiation protocol (SIP) phone, a laptop, a personal digital assistant (PDA), a satellite radio, a Global Positioning System device, a multimedia device, a video device, a digital audio player, a camera, a game console, a tablet, a smart device, a wearable device, a vehicle, an electric meter, a gas pump, a kitchen appliance, a healthcare device, an implant, a sensor/actuator, a display, an Internet of Things (IoT) device, an always on (AON) device, an edge processing device, a data center, or another similar device. A UE 104 may also be referred to as a mobile device, a wireless device, a station, a mobile station, a subscriber station, a mobile subscriber station, a mobile unit, a subscriber unit, a wireless unit, a remote unit, a remote device, an access terminal, a mobile terminal, a wireless terminal, a remote terminal, a handset, and others.

BSs 102 wirelessly communicate with (e.g., transmit signals to or receive signals from) UEs 104 via communications links 120. A communications link 120 between a BS 102 and a UE 104 may include uplink (UL) (also referred to as reverse link) transmissions from a UE 104 to a BS 102 and/or downlink (DL) (also referred to as forward link) transmissions from a BS 102 to a UE 104. A communications link 120 may use multiple-input and multiple-output (MIMO) antenna technology, including spatial multiplexing, beamforming, and/or transmit diversity in various aspects.

A BS 102 may include a NodeB, an enhanced NodeB (eNB), a next generation enhanced NodeB (ng-eNB), a next generation NodeB (gNB or gNodeB), an access point, a base transceiver station, a radio base station, a radio transceiver, a transceiver function, a transmission reception point (TRP), a radio unit (RU), a distributed unit (DU), or the like. A given BS 102 may provide communications coverage for a coverage area 110, which may sometimes be referred to as a cell, and which may overlap another coverage area 110 (e.g., a small cell provided by a BS 102′) may have a coverage area 110′ that overlaps the coverage area 110 of a macro cell). A BS 102 may, for example, provide communications coverage for a macro cell (covering a relatively large geographic area), a pico cell (covering a relatively smaller geographic area, such as a sports stadium), a femto cell (covering a relatively smaller geographic area, such as a home), or another type of cell.

The term “cell” may refer to a portion, partition, or segment of wireless communication coverage served by a network entity within a wireless communications network 100. A cell may have geographic characteristics, such as a geographic coverage area, as well as radio frequency characteristics, such as time and/or frequency resources dedicated to the cell. For example, a specific geographic coverage area may be covered by multiple cells employing different frequency resources (e.g., bandwidth parts) and/or different time resources. As another example, a specific geographic coverage area may be covered by a single cell. In some contexts (e.g., a carrier aggregation scenario and/or multi-connectivity scenario), the terms “cell” or “serving cell” may refer to or correspond to a specific carrier frequency (e.g., a component carrier) used for wireless communications, and a “cell group” may refer to or correspond to multiple carriers used for wireless communications. As examples, in a carrier aggregation scenario, a UE may communicate on multiple component carriers corresponding to multiple (serving) cells in the same cell group, and in a multi-connectivity (e.g., dual connectivity) scenario, a UE may communicate on multiple component carriers corresponding to multiple cell groups.

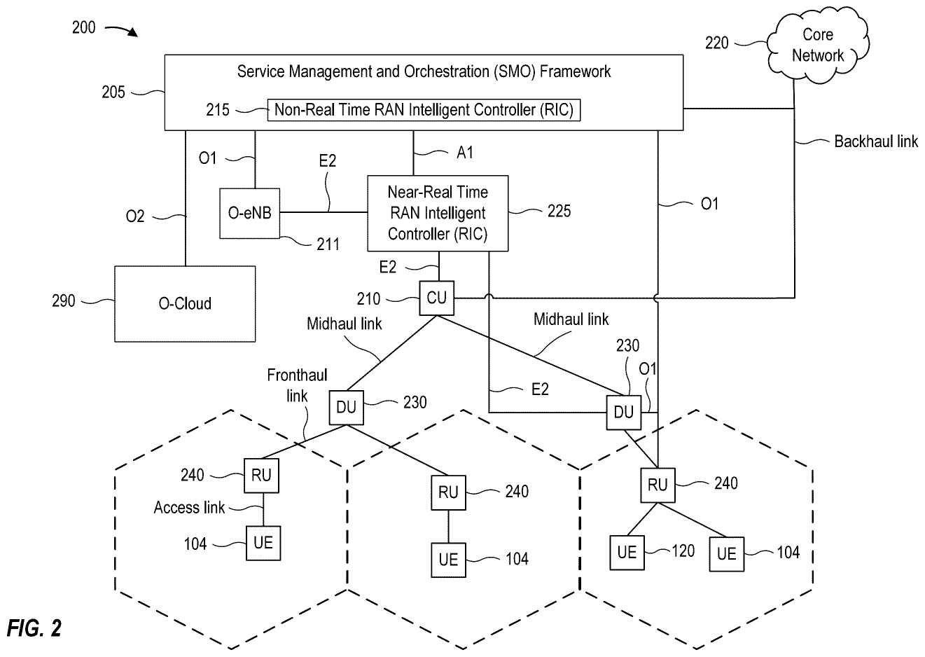

While BSs 102 are depicted in various aspects as unitary communications devices, BSs 102 may be implemented in various configurations. For example, one or more components of a base station may be disaggregated, including a central unit (CU), one or more DUs, one or more RUs, a Near-Real Time (Near-RT) RAN Intelligent Controller (RIC), or a Non-Real Time (Non-RT) RIC, to name a few examples. In another example, various aspects of a base station may be virtualized. A base station (e.g., BS 102) may include components that are located at a single physical location or components located at various physical locations. In examples in which a base station includes components that are located at various physical locations, the various components may each perform functions such that, collectively, the various components achieve functionality that is similar to a base station that is located at a single physical location. Implementing a base station in this fashion may provide efficiency gains by enabling cloud-based implementation of certain (e.g., non-time-sensitive) higher-layer functions while physical-layer or other lower-layer functions can be implemented at or in proximity to a geographic coverage area of a corresponding cell. In some aspects, a base station including components that are located at various physical locations may be referred to as having a disaggregated RAN architecture, such as an Open RAN (O-RAN) or Virtualized RAN (VRAN) architecture. FIG. 2 depicts and describes an example disaggregated RAN architecture.

Different BSs 102 within wireless communications network 100 may also be configured to support different radio access technologies, such as 3G, 4G, 5G, and/or 6G. For example, BSs 102 configured for 4G LTE (collectively referred to as Evolved Universal Mobile Telecommunications System (UMTS) Terrestrial Radio Access Network (E-UTRAN)) may interface with the EPC 160 through first backhaul links 132 (e.g., an S1 interface). BSs 102 configured for 5G (e.g., 5G New Radio (NR) or Next Generation RAN (NG-RAN)) may interface with 5GC 190 through second backhaul links 184. BSs 102 may communicate directly or indirectly (e.g., through the EPC 160 or the 5GC 190) with each other over third backhaul links 134 (e.g., an X2 or XN interface), which may be wired or wireless.

Wireless communications network 100 may subdivide the electromagnetic spectrum into various classes, bands, channels, or other features. In some aspects, the subdivision is provided based on wavelength and frequency, where frequency may also be referred to as a carrier, a subcarrier, a frequency channel, a tone, or a subband. For example, the Third Generation Partnership Project (3GPP) currently defines Frequency Range 1 (FR1) as including 410 megahertz (MHz)-7125 MHz, which is often referred to (interchangeably) as “Sub-6 gigahertz (GHz)”. Similarly, 3GPP currently defines Frequency Range 2 (FR2) as including 24,250 MHz-71,000 MHz, which is sometimes referred to (interchangeably) as a “millimeter wave” (“mmW” or “mmWave”). In some cases, FR2 may be further defined in terms of sub-ranges, such as a first sub-range FR2-1 including 24,250 MHz-52,600 MHz and a second sub-range FR2-2 including 52,600 MHz-71,000 MHz. A base station configured to communicate using mmWave/near mmWave radio frequency bands (e.g., a mmWave base station such as BS 180) may utilize beamforming (e.g., 182) with a UE (e.g., 104) to improve path loss and range.

A communications links 120 may be through one or more carriers, which may have different bandwidths (e.g., 5 MHz, 10 MHz, 15 MHz, 20 MHz, 100 MHz, 400 MHz, and/or other bandwidths), and which may be aggregated in various aspects. Carriers may or may not be adjacent to each other. Allocation of carriers may be asymmetric with respect to DL and UL (e.g., more or fewer carriers may be allocated for DL than for UL).

Communications using higher frequency bands may have higher path loss and a shorter range compared to lower frequency communications. Accordingly, certain base stations (e.g., BS 180 in FIG. 1) may utilize beamforming (indicated by reference number 182) with a UE 104 to improve path loss and range. For example, BS 180 and the UE 104 may each include a plurality of antennas, such as antenna elements, antenna panels, and/or antenna arrays to facilitate the beamforming. In some cases, BS 180 may transmit a beamformed signal to UE 104 in one or more transmit directions 182′. UE 104 may receive the beamformed signal from the BS 180 in one or more receive directions 182″. UE 104 may also transmit a beamformed signal to the BS 180 in one or more transmit directions 182″. BS 180 may also receive the beamformed signal from UE 104 in one or more receive directions 182′. BS 180 and UE 104 may perform beam training to determine suitable receive and transmit directions for each of BS 180 and UE 104. Notably, the transmit and receive directions for BS 180 may or may not be the same. Similarly, the transmit and receive directions for UE 104 may or may not be the same.

Wireless communications network 100 may include a Wi-Fi access point (AP) 150 in communication with Wi-Fi stations (STAs) 152 via communications links 154 in, for example, a 2.4 GHz and/or 5 GHz unlicensed frequency spectrum.

Certain UEs 104 may communicate with each other using device-to-device (D2D) communications link 158. In some examples, D2D communications link 158 may use one or more sidelink channels, such as a physical sidelink broadcast channel (PSBCH), a physical sidelink discovery channel (PSDCH), a physical sidelink shared channel (PSSCH), a physical sidelink control channel (PSCCH), and/or a physical sidelink feedback channel (PSFCH). D2D communications link 158 may be implemented using a variety of technologies, such as a radio access technology (e.g., 5G, ProSe sidelink), a WiFi technology, a Bluetooth technology, or the like.

EPC 160 may include various functional components, such as a Mobility Management Entity (MME) 162, other MMEs 164, a Serving Gateway 166, a Multimedia Broadcast Multicast Service (MBMS) Gateway 168, a Broadcast Multicast Service Center (BM-SC) 170, and/or a Packet Data Network (PDN) Gateway 172. MME 162 may be in communication with a Home Subscriber Server (HSS) 174. MME 162 is a control node that processes signaling between the UEs 104 and the EPC 160. Generally, MME 162 provides bearer and connection management.

Generally, user Internet protocol (IP) packets are transferred through Serving Gateway 166. Serving gateway 166 is connected to PDN Gateway 172. PDN Gateway 172 provides UE IP address allocation as well as other functions. PDN Gateway 172 and BM-SC 170 are connected to IP Services 176, which may include, for example, the Internet, an intranet, an IP Multimedia Subsystem (IMS), a Packet Switched (PS) streaming service, and/or other IP services.

BM-SC 170 may provide functions for MBMS user service provisioning and delivery. BM-SC 170 may serve as an entry point for content provider MBMS transmission, may be used to authorize and initiate MBMS Bearer Services within a public land mobile network (PLMN), and/or may be used to schedule MBMS transmissions. MBMS Gateway 168 may be used to distribute MBMS traffic to the BSs 102 belonging to a Multicast Broadcast Single Frequency Network (MBSFN) area broadcasting a particular service, and/or may be responsible for session management (start/stop) and for collecting eMBMS related charging information.

5GC 190 may include various functional components, such as an Access and Mobility Management Function (AMF) 192, other AMFs 193, a Session Management Function (SMF) 194, and a User Plane Function (UPF) 195. AMF 192 may be in communication with Unified Data Management (UDM) 196.

AMF 192 is a control node that processes signaling between UEs 104 and the 5GC 190. AMF 192 provides, for example, quality of service (QoS) flow and session management.

IP packets are transferred through UPF 195, which is connected to the IP Services 197. UPF 195 may provide UE IP address allocation as well as other functions for 5GC 190. IP Services 197 may include, for example, the Internet, an intranet, an IMS, a PS streaming service, and/or other IP services.

In various aspects, a network entity or network node can be implemented as an aggregated base station, as a disaggregated base station, a component of a base station, an integrated access and backhaul (IAB) node, a relay node, a core network entity, or a sidelink node, to name a few examples.

UE 104 includes a codebook component 198, which may be used to communicate based on a deployment-specific precoding codebook as further described herein. Further, a BS 102 includes a codebook component 199, which may be used to communicate based on a deployment-specific precoding codebook as further described herein.

FIG. 2 depicts an example disaggregated base station 200 architecture. The disaggregated base station 200 architecture may include one or more CUs 210 that can communicate directly with a core network 220 or other CUs 210 via a backhaul link (such as backhaul link 134), or indirectly with the core network 220 through one or more disaggregated base station units (such as a Near-Real Time (Near-RT) RAN Intelligent Controller (RIC) 225 via an E2 link, a Non-Real Time (Non-RT) RIC 215 associated with a Service Management and Orchestration (SMO) Framework 205, or both). A CU 210 may communicate with one or more DUs 230 via respective midhaul links, such as an F1 interface. The DUs 230 may communicate with one or more RUs 240 via respective fronthaul links. The RUs 240 may communicate with respective UEs 104 via one or more radio frequency (RF) access links (such as communication link 120). In some implementations, a UE 104 may be simultaneously served by multiple RUs 240.

Each of the units, e.g., the CUS 210, the DUs 230, the RUs 240, as well as the Near-RT RICs 225, the Non-RT RICs 215 and the SMO Framework 205, may include one or more interfaces or be coupled to one or more interfaces configured to receive or transmit signals, data, or information (collectively, signals) via a wired or wireless transmission medium. Each of the units, or a processor or controller providing instructions to the interfaces of the units, can be configured to communicate with one or more of the other units via the transmission medium. For example, the units can include a wired interface configured to receive or transmit signals over a wired transmission medium to one or more of the other units. Additionally or alternatively, the units can include a wireless interface, which may include a receiver, a transmitter, or a transceiver (such as a RF transceiver), configured to receive or transmit signals, or both, over a wireless transmission medium.

In some aspects, the CU 210 may host one or more higher layer control functions. Such control functions can include radio resource control (RRC), packet data convergence protocol (PDCP), service data adaptation protocol (SDAP), or the like. Each control function can be implemented with an interface configured to communicate signals with other control functions hosted by the CU 210. The CU 210 may be configured to handle user plane functionality (e.g., Central Unit-User Plane (CU-UP)), control plane functionality (e.g., Central Unit-Control Plane (CU-CP)), or a combination thereof. In some implementations, the CU 210 can be logically split into one or more CU-UP units and one or more CU-CP units. The CU-UP unit can communicate bidirectionally with the CU-CP unit via an interface, such as the E1 interface when implemented in an O-RAN configuration. The CU 210 can be implemented to communicate with the DU 230 for network control and signaling.

The DU 230 may be or correspond to a logical unit that includes one or more base station functions to control the operation of one or more RUs 240. In some aspects, the DU 230 may host one or more of a radio link control (RLC) layer, a medium access control (MAC) layer, and one or more high physical (PHY) layers (such as modules for forward error correction (FEC) encoding and decoding, scrambling, modulation and demodulation, or the like) depending, at least in part, on a functional split, such as those defined by the 3rd Generation Partnership Project (3GPP). In some aspects, the DU 230 may further host one or more low PHY layers. Each layer (or module) can be implemented with an interface configured to communicate signals with other layers (and modules) hosted by the DU 230, or with the control functions hosted by the CU 210.

Lower-layer functionality can be implemented by one or more RUs 240. In some deployments, an RU 240, controlled by a DU 230, may correspond to a logical node that hosts RF processing functions, or low-PHY layer functions (such as performing fast Fourier transform (FFT), inverse FFT (iFFT), digital beamforming, physical random access channel (PRACH) extraction and filtering, or the like), or both, based at least in part on the functional split, such as a lower layer functional split. In such an architecture, the RU(s) 240 can be implemented to handle over the air (OTA) communications with one or more UEs 104. In some implementations, real-time and non-real-time aspects of control and user plane communications with the RU(s) 240 can be controlled by the corresponding DU 230. In some scenarios, this configuration can enable the DU(s) 230 and the CU 210 to be implemented in a cloud-based RAN architecture, such as a vRAN architecture.

The SMO Framework 205 may be configured to support RAN deployment and provisioning of non-virtualized and virtualized network elements. For non-virtualized network elements, the SMO Framework 205 may be configured to support the deployment of dedicated physical resources for RAN coverage requirements which may be managed via an operations and maintenance interface (such as an O1 interface). For virtualized network elements, the SMO Framework 205 may be configured to interact with a cloud computing platform (such as an open cloud (O-Cloud) 290) to perform network element life cycle management (such as to instantiate virtualized network elements) via a cloud computing platform interface (such as an O2 interface). Such virtualized network elements can include, but are not limited to, CUs 210, DUs 230, RUs 240 and Near-RT RICs 225. In some implementations, the SMO Framework 205 can communicate with a hardware aspect of a 4G RAN, such as an open eNB (O-eNB) 211, via an O1 interface. Additionally, in some implementations, the SMO Framework 205 can communicate directly with one or more DUs 230 and/or one or more RUs 240 via an O1 interface. The SMO Framework 205 also may include a Non-RT RIC 215 configured to support functionality of the SMO Framework 205.

The Non-RT RIC 215 may be configured to include a logical function that enables non-real-time control and optimization of RAN elements and resources, Artificial Intelligence/Machine Learning (AI/ML) workflows including model training and updates, or policy-based guidance of applications/features in the Near-RT RIC 225. The Non-RT RIC 215 may be coupled to or communicate with (such as via an A1 interface) the Near-RT RIC 225. The Near-RT RIC 225 may be configured to include a logical function that enables near-real-time control and optimization of RAN elements and resources via data collection and actions over an interface (such as via an E2 interface) connecting one or more CUs 210, one or more DUs 230, or both, as well as an O-eNB, with the Near-RT RIC 225.

In some implementations, to generate AI/ML models to be deployed in the Near-RT RIC 225, the Non-RT RIC 215 may receive parameters or external enrichment information from external servers. Such information may be utilized by the Near-RT RIC 225 and may be received at the SMO Framework 205 or the Non-RT RIC 215 from non-network data sources or from network functions. In some examples, the Non-RT RIC 215 or the Near-RT RIC 225 may be configured to tune RAN behavior or performance. For example, the Non-RT RIC 215 may monitor long-term trends and patterns for performance and employ AI/ML models to perform corrective actions through the SMO Framework 205 (such as reconfiguration via O1) or via creation of RAN management policies (such as A1 policies).

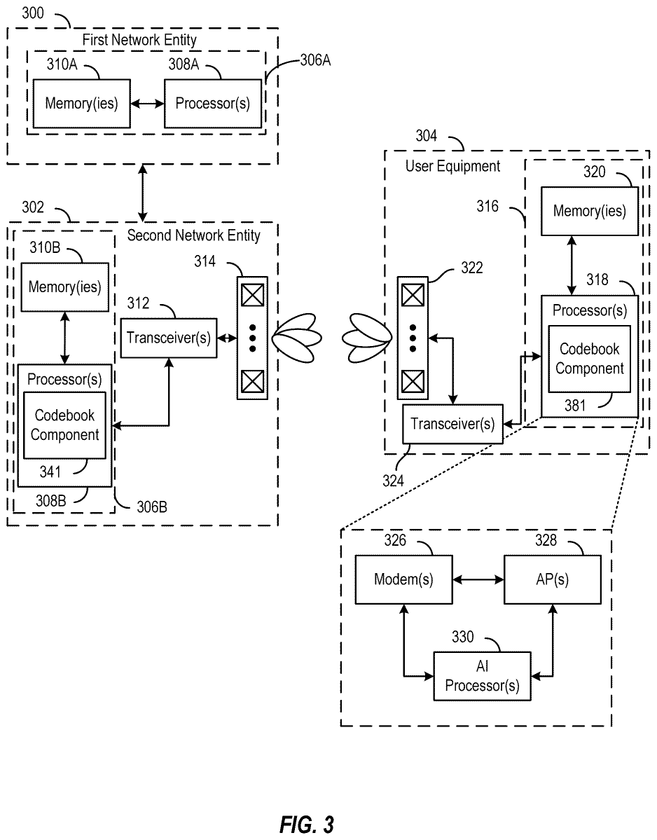

FIG. 3 depicts aspects of network entities 300 and 302 and a UE 304.

FIG. 3 includes a first network entity 300 and a second network entity 302. In some examples, first network entity 300 may be an example of a CU 210 or a DU 230. In some examples, second network entity 302 may be an example of a DU 230 or an RU 240. First network entity 300 and second network entity 302 may communicate with one another via a communications link, such as a midhaul link. In some examples, first network entity 300 and second network entity 302 may be implemented at a same BS (e.g., BS 102). For example, first network entity 300 and second network entity 302 may be co-located. In some other examples, first network entity 300 may be implemented separately from second network entity 302. For example, first network entity 300 may be implemented as a function (e.g., one or more processes) running on a server, such as in a cloud (e.g., a public or private cloud). As another example, first network entity 300 may be implemented as a virtual computing instance (e.g., virtual machine, container, etc.) or as a physical server.

First network entity 300 and second network entity 302 each include a processing system 306, illustrated as “processing system 306A” at first network entity 300 and “processing system 306B” at second network entity 302. For example, first network entity 300 and second network entity 302 may include one or more chips, system-on-chips (SoCs), system-in-packages (SiPs), chipsets, packages, or devices that individually or collectively constitute or comprise a processing system 306. A processing system 306 includes one or more processors 308 (illustrated as “processor(s) 308A” and “processor(s) 308B”) and one or more memories 310 (illustrated as “memory(ies) 310A” and “memory(ies) 310B”) coupled to the one or more processors 308. The one or more processors 308 may include one or multiple processors, microprocessors, processing units (such as central processing units (CPUs), graphics processing units (GPUs), neural processing units (NPUs) (also referred to as neural network processors or deep learning processors (DLPs)) and/or digital signal processors (DSPs)), processing blocks, application-specific integrated circuits (ASIC), programmable logic devices (PLDs) (such as field programmable gate arrays (FPGAs)), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. A group of processors collectively configurable or configured to perform a set of functions may include a first processor configurable or configured to perform a first function of the set and a second processor configurable or configured to perform a second function of the set. In some other examples, each of a group of processors may be configurable or configured to perform a same set of functions.

In some aspects, the processing system 306 may perform processing (such as digital signal processing) of data, control information, or signals received or transmitted by a network entity. For example, the processing system 306 may include a coder, a decoder, a multiplexer, a demultiplexer, a transmit MIMO processor, a transmit processor, a receive processor, a receive MIMO detector, an automatic gain control component, or the like.

The one or more memories 310 may include one or more memory devices, memory blocks, memory elements or other discrete gate or transistor logic or circuitry, each of which may include tangible storage media such as random-access memory (RAM) or read-only memory (ROM), or combinations thereof (all of which may be generally referred to herein individually as “memories” or collectively as “the memory” or “the memory circuitry”). The one or more memories 310 may store data and program code for first network entity 300 and/or second network entity 302.

As further shown, second network entity 302 includes one or more transceivers 312 (illustrated as “transceiver(s) 312”). The one or more transceivers 312 may perform processing related to implementing physical layer (e.g., radio, air interface) communication with other devices such as UE 304. The one or more transceivers 312 may include one or more radio frequency (RF) components, such as an RF transceiver, a front-end module (e.g., an RF front-end (RFFE)), or the like. For example, the one or more transceivers 312 may include a transmit path (also referred to as a transmit chain), a receive path (also referred to as a receive chain), and/or an interface with one or more antennas 314.

The one or more antennas 314 may perform wireless transmission and reception of signals. The one or more antennas 314 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

UE 304 may be an example of UE 104. As shown, UE 304 includes a processing system 316. For example, UE 304 may include one or more chips, SoCs, SiPs, chipsets, packages, or devices that individually or collectively constitute or comprise a processing system 316. A processing system 316 includes one or more processors 318, and one or more memories 320 coupled to the one or more processors 318. Further, UE 304 includes one or more antennas 322, one or more transceivers 324, and/or other components that enable wireless transmission and reception of data.

The one or more processors 318 may include one or multiple processors, microprocessors, processing units (such as CPUs, GPUs, NPUs (also referred to as neural network processors or DLPs) and/or DSPs), processing blocks, ASICs, PLDs (such as FPGAs), or other discrete gate or transistor logic or circuitry (any one or more of which may be generally referred to herein individually as a “processor” or collectively as “the processor” or “the processor circuitry”). One or more of the processors may be individually or collectively configurable or configured to perform various functions or operations described herein. In some aspects, the processing system 316 may perform processing (such as digital signal processing) of data, control information, or signals received or transmitted by a network entity. For example, the processing system 316 may include a coder, a decoder, a multiplexer, a demultiplexer, a transmit MIMO processor, a transmit processor, a receive processor, a receive MIMO detector, an automatic gain control component, or the like.

As shown, in some examples, the one or more processors 318 may include one or more modems 326, one or more application processors (APs) 328, one or more AI processors 330, a combination thereof, and/or another form of processor.

The one or more modems 326 may include a digital signal processor that converts information into a waveform for analog signal transmission (e.g., via modulation) and/or converts the waveform of a received signal into information (e.g., via demodulation). The one or more modems 326 may process information or waveforms in connection with signal transmission or reception. For example, the one or more modems 326 may include a coder, a decoder, a multiplexer, a demultiplexer, a transmit MIMO processor, a transmit processor, a receive processor, a receive MIMO detector, an automatic gain control component, or the like.

The one or more APs 328 may perform processing relating to an operating system and/or a higher layer application of the UE 304. For example, the one or more APs 328 may provide a higher-level operating system (HLOS), software, audio or video processing, graphics processing, or the like. In some examples, the one or more APs 328 may be a data source (e.g., for transmissions) or a data sink (e.g., for receptions).

The one or more transceivers 324 may perform processing related to implementing physical layer (e.g., radio, air interface) communication with other devices such as other UEs 304 or second network entity 302. The one or more transceivers 324 may include one or more RF components, such as an RF transceiver, a front-end module (e.g., an RFFE), or the like. For example, the one or more transceivers 324 may include a transmit path (also referred to as a transmit chain), a receive path (also referred to as a receive chain), and/or an interface with one or more antennas 322.

The one or more antennas 322 may perform wireless transmission and reception of signals. The one or more antennas 322 may include, or may be included within, one or more antenna panels, one or more antenna groups, one or more sets of antenna elements, or one or more antenna arrays, among other examples. An antenna panel, an antenna group, a set of antenna elements, or an antenna array may include one or more antenna elements (within a single housing or multiple housings), a set of coplanar antenna elements, a set of non-coplanar antenna elements, or one or more antenna elements coupled with one or more transmission or reception components, such as one or more components of FIG. 3.

For an example downlink transmission by second network entity 302, the processing system 306 (e.g., a transmit processor) may receive data and/or control information. The control information may be for the physical broadcast channel (PBCH), physical control format indicator channel (PCFICH), physical hybrid automatic repeat request (HARQ) indicator channel (PHICH), physical downlink control channel (PDCCH), group common PDCCH (GC PDCCH), and/or others. The data may be for the physical downlink shared channel (PDSCH), in some examples.

The processing system 306 (e.g., a transmit processor) may process (e.g., encode and symbol map) the data and control information to obtain data symbols and control symbols, respectively. The processing system 306 may also generate reference symbols, such as for the primary synchronization signal (PSS), secondary synchronization signal (SSS), PBCH demodulation reference signal (DMRS), or channel state information reference signal (CSI-RS).

The processing system 306 (e.g., a transmit (TX) MIMO processor) may perform spatial processing (e.g., precoding) on the data symbols, the control symbols, and/or the reference symbols, if applicable, and may provide output symbol streams to one or more modulators of the processing system 306. The one or more modulators may process one or more respective output symbol streams to obtain an output sample stream. The one or more transceivers 312 may process (e.g., convert to analog, amplify, filter, and upconvert) the output sample stream to obtain a downlink signal. Second network entity 302 may transmit the downlink signal via the one or more antennas 314.

In order to receive the downlink transmission at UE 304 (or a sidelink transmission from another UE), the one or more antennas 322 may receive the downlink signal and may provide received signals to the one or more transceivers 324. The one or more transceivers 324 may condition (e.g., filter, amplify, downconvert, and digitize) the received signals to obtain input samples. The one or more transceivers 324 and/or the processing system 316 may further process the input samples to obtain received symbols.

The processing system 316 (e.g., modem 326, a receive (RX) MIMO detector) may obtain the received symbols, perform MIMO detection on the received symbols if applicable, and provide detected symbols. The processing system 316 (e.g., a modem 326, a receive processor) may process (e.g., de-interleave and decode) the detected symbols. The processing system 316 may provide decoded data for the UE 304 (e.g., to an AP 328) and/or decoded control information (e.g., to a controller/processor of the processing system 316).

For an example uplink transmission or a sidelink transmission from UE 304, the processing system 316 (e.g., modem 326, a transmit processor) may receive and process data and/or control information to obtain a set of symbols for transmission. The data may be for the physical uplink shared channel (PUSCH), and may be received from a data source such as the AP 328. The control information may be for the physical uplink control channel (PUCCH), and may be received, for example, from a controller/processor of the processing system 316. The processing system 316 (e.g., a modem 326, the transmit processor) may also generate reference symbols for a reference signal (e.g., for a sounding reference signal (SRS), a demodulation reference signal, a phase tracking reference signal, or the like). In some examples, the symbols and/or reference signals may be precoded by the processing system 316 (e.g., modem 326, a TX MIMO processor), further processed by the one or more transceivers 324 (e.g., for single-carrier frequency division multiplexing (SC-FDM)), and transmitted to second network entity 302.

At second network entity 302, the uplink signals from UE 304 may be received by the one or more antennas 314, conditioned by the one or more transceivers 312 (e.g., filtered, amplified, downconverted, and digitized), detected (e.g., by the processing system 306B such as a modem and/or an RX MIMO detector), and further processed by the processing system 306B (e.g., a modem and/or a receive processor) to obtain decoded data and control information sent by UE 304. The processing system 306B may provide the decoded data and the decoded control information (such as to a controller/processor of the processing system 306B, an AP, first network entity 300, or another entity).

In various aspects, a wireless communication device, such as first network entity 300, second network entity 302, BS 102, UE 104, or UE 304 may be described as sending, transmitting, obtaining, or receiving various types of data associated with the methods described herein. In these contexts, “transmitting” or “sending” may refer to various mechanisms of outputting data, such as outputting data from a processing system, one or more memories, one or more transceivers, one or more antennas, and/or other aspects described herein. For example, “sending” or “transmitting” by a device may include sending (such as wirelessly, via a wired connection, or both) to a recipient directly or via another device. As another example, “sending” or “transmitting” may include sending internally to a device (such as the UE 304, first network entity 300, or second network entity 302) by a process to memory. “Receiving” or “obtaining” may refer to various mechanisms of obtaining data, such as obtaining data from the processing system, one or more memories, one or more transceivers, one or more antennas, and/or other aspects described herein. For example, “receiving” or “obtaining” by a device may include obtaining (such as wirelessly, via a wired connection, or both) from a recipient directly or via another device. As another example, “receiving” or “obtaining” may include obtaining internally to a device (such as the UE 304, first network entity 300, or second network entity 302) by a process from memory. As used herein, “communicating” by a device may include sending, obtaining, receiving, and/or transmitting a communication. “Communicating” can refer to communication with another device or internal communication of the device.

In various aspects, the processing system 306 or the processing system 316 may include one or more AI processors (such as AI processor 330 of the processing system 316). An AI processor may perform AI processing. The AI processor may include AI accelerator hardware or circuitry such as one or more neural processing units (NPUs), one or more neural network processors, one or more tensor processors, one or more deep learning processors, etc. As an example, the AI processor may perform AI-based beam management, AI-based channel state feedback (CSF), AI-based antenna tuning, and/or AI-based positioning (e.g., non-line of sight positioning prediction). In some cases, at the UE 104, the AI processor may process feedback generated by the UE 304 (e.g., CSF) using hardware accelerated AI inferences and/or AI training. In some cases, at the second network entity 302, the AI processor may decode compressed CSF from the UE 304, for example, using a hardware accelerated AI inference associated with the CSF. In certain cases, the AI processor may perform certain RAN-based functions including, for example, network planning, network performance management, energy-efficient network operations, etc.

In the depicted example, the processor(s) 308B includes a codebook component 341, which may be representative of the codebook component 199 of FIG. 1. Notably, while depicted as an aspect of processor(s) 308B, the codebook component 341 may be implemented additionally or alternatively in various other aspects of a network entity or a BS 102 in other implementations. Further, the processor(s) 318 includes a codebook component 381, which may be representative of the codebook component 198 of FIG. 1. Notably, while depicted as an aspect of the processor(s) 318, the codebook component 381 may be implemented additionally or alternatively in various other aspects of a UE 104 in other implementations.

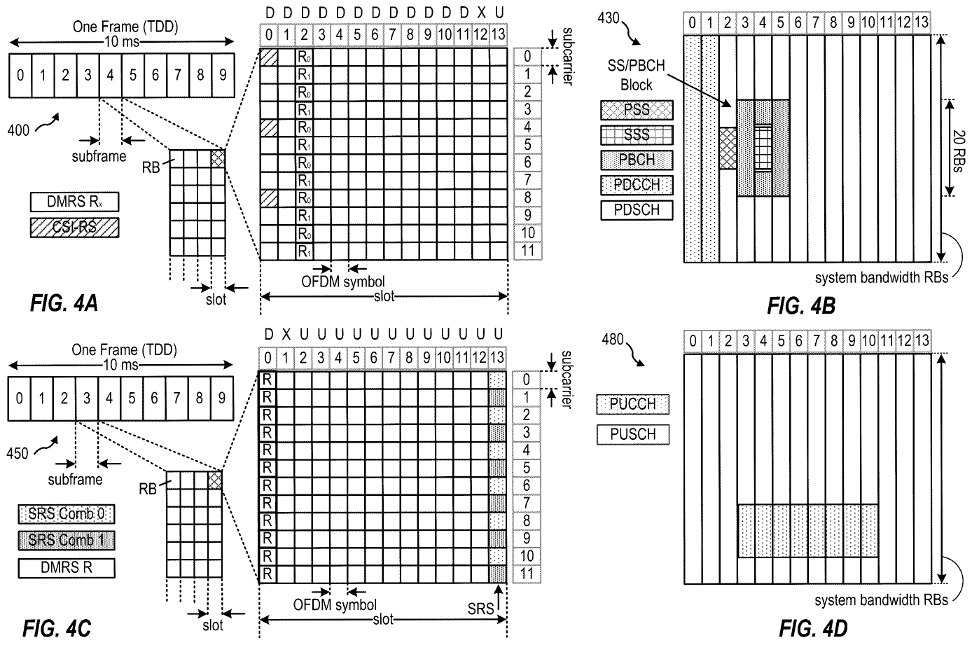

FIGS. 4A, 4B, 4C, and 4D depict aspects of data structures for a wireless communications network, such as wireless communications network 100 of FIG. 1.

FIG. 4A is a diagram 400 illustrating an example of a first subframe within a 5G (e.g., 5G NR) frame structure, FIG. 4B is a diagram 430 illustrating an example of DL channels within a 5G subframe, FIG. 4C is a diagram 450 illustrating an example of a second subframe within a 5G frame structure, and FIG. 4D is a diagram 480 illustrating an example of UL channels within a 5G subframe.

Wireless communications systems may utilize orthogonal frequency division multiplexing (OFDM) with a cyclic prefix (CP) on the uplink and downlink. Such systems may also support half-duplex operation using time division duplexing (TDD). OFDM and SC-FDM partition the system bandwidth (e.g., as depicted in FIGS. 4B and 4D) into multiple orthogonal subcarriers. One or more subcarriers may be modulated with data. Modulation symbols may be sent in the frequency domain with OFDM and/or in the time domain with SC-FDM.

In some examples, a wireless communications frame structure may be implemented using frequency division duplexing (FDD). In FDD, some subcarriers may be configured for DL communication, and other subcarriers (which may overlap in time with the DL subcarriers) may be configured for UL communication. In some other examples, wireless communications frame structures may be implemented using time division duplexing (TDD). In TDD, for a particular set of subcarriers, some subframes are configured for DL communication and other subframes are configured for UL communication.

In FIGS. 4A and 4C, the wireless communications frame structure is implemented using TDD. “D” indicates DL time resources, “U” indicates UL time resources, and “X” indicates flexible time resources for use or later reconfiguration for either DL or UL communication. UEs may be configured with a slot format through a received slot format indicator (SFI) (dynamically through DL control information (DCI), or semi-statically/statically through radio resource control (RRC) signaling). In the depicted examples, a 10 ms frame is divided into 10 equally sized 1 ms subframes. Each subframe may include one or more time slots. In some examples, each slot may include 12 or 14 symbols, depending on the cyclic prefix (CP) type (e.g., 12 symbols per slot for an extended CP or 14 symbols per slot for a normal CP). Subframes may also include mini-slots, which generally have fewer symbols than an entire slot. Other wireless communications technologies may have a different frame structure and/or different channels.

In certain aspects, the number of slots within a subframe (e.g., a slot duration in a subframe) is based on a numerology. A numerology may define a frequency domain subcarrier spacing and symbol duration, and may be configured for a given bandwidth part, carrier, cell, or network entity. In certain aspects, given a numerology u, there are 24 slots per subframe. Thus, numerologies (μ) 0 to 6 may allow for 1, 2, 4, 8, 16, 32, and 64 slots, respectively, per subframe. In some cases, an extended CP (e.g., 12 symbols per slot) may be used with a specific numerology, such as numerology μ=2 allowing for 4 slots per subframe. The subcarrier spacing and symbol length/duration are a function of the numerology. The subcarrier spacing may be equal to 24× 15 kHz. As an example, the numerology μ=0 corresponds to a subcarrier spacing of 15 kHz, and the numerology μ=6 corresponds to a subcarrier spacing of 960 kHz. The symbol length/duration is inversely related to the subcarrier spacing. FIGS. 4A, 4B, 4C, and 4D provide an example of a slot format having 14 symbols per slot (e.g., a normal CP) and a numerology μ=2 with 4 slots per subframe. In such a case, the slot duration is 0.25 ms, the subcarrier spacing is 60 kHz, and the symbol duration is approximately 16.67 μs.

As depicted in FIGS. 4A, 4B, 4C, and 4D, a resource grid may be used to represent the frame structure. Each time slot includes a resource block (RB) (also referred to as a physical RB (PRB)) that extends across, for example, 12 consecutive subcarriers. The resource grid is divided into multiple resource elements (REs). An RE may include a single subcarrier in the frequency domain and a single symbol in the time domain. The number of bits carried by each RE depends on the modulation scheme including, for example, quadrature phase shift keying (QPSK) or quadrature amplitude modulation (QAM).

As illustrated in FIG. 4A, some of the REs carry reference (pilot) signals (shown as “RS”) for a UE (e.g., UE 104 of FIGS. 1 and 3). The RS may include a demodulation RS (DMRS) and/or a channel state information reference signals (CSI-RS) for channel estimation at the UE. The RS may additionally or alternatively include a beam measurement RS (BRS), a beam refinement RS (BRRS), and/or a phase tracking RS (PT-RS).

FIG. 4B illustrates an example of various DL channels within a subframe of a frame. The physical downlink control channel (PDCCH) carries DCI within one or more control channel elements (CCEs), each CCE including, for example, nine RE groups (REGs), each REG including, for example, four consecutive REs in an OFDM symbol.

A primary synchronization signal (PSS) may be within symbol 2 of particular subframes of a frame. The PSS is used by a UE (e.g., 104 of FIGS. 1 and 3) to determine subframe/symbol timing and a physical layer identity.

A secondary synchronization signal (SSS) may be within symbol 4 of particular subframes of a frame. The SSS is used by a UE to determine a physical layer cell identity group number and radio frame timing.

Based on the physical layer identity and the physical layer cell identity group number, the UE can determine a physical cell identifier (PCI). Based on the PCI, the UE can determine the locations of the aforementioned DMRS. The physical broadcast channel (PBCH), which carries a master information block (MIB), may be logically grouped with the PSS and SSS to form a synchronization signal (SS)/PBCH block (SSB), and in some cases, referred to as a synchronization signal block (SSB). The MIB provides a number of RBs in the system bandwidth and a system frame number (SFN). The physical downlink shared channel (PDSCH) carries user data, broadcast system information not transmitted through the PBCH such as system information blocks (SIBs), and/or paging messages.

As illustrated in FIG. 4C, some of the REs carry DMRS (indicated as “R” for one particular configuration, but other DMRS configurations are possible) for channel estimation at the base station. The UE may transmit DMRS for the PUCCH and DMRS for the PUSCH. The PUSCH DMRS may be transmitted, for example, in the first one or two symbols of the PUSCH. The PUCCH DMRS may be transmitted in different configurations depending on whether short or long PUCCHs are transmitted and depending on the particular PUCCH format used. UE 104 may transmit sounding reference signals (SRS). The SRS may be transmitted, for example, in the last symbol of a subframe. The SRS may have a comb structure, and a UE may transmit SRS on one of the combs. The SRS may be used by a base station for channel quality estimation to enable frequency-dependent scheduling on the UL.

FIG. 4D illustrates an example of various UL channels within a subframe of a frame. The PUCCH may be located as indicated in one configuration. The PUCCH carries uplink control information (UCI), such as scheduling requests, a channel quality indicator (CQI), a precoding matrix indicator (PMI), a rank indicator (RI), and HARQ acknowledgment (ACK)/negative acknowledgment (NACK) feedback. The PUSCH carries data, and may additionally be used to carry a buffer status report (BSR), a power headroom report (PHR), and/or UCI.

### Aspects Related to Channel State Feedback

In certain wireless communication networks, closed-loop feedback associated with a communication channel between a UE and a network entity may be used to dynamically adapt communication parameters to channel conditions that may change over time. In certain cases, a UE may transmit a reference signal (e.g., DMRS, SRS, etc.), and a network entity (or another UE) may determine characteristics associated with the channel based on measurements of the received reference signal. In some cases, a UE may receive a reference signal (e.g., SSB, CSI-RS, DMRS, PT-RS, tracking reference signal (TRS), etc.) from a network entity (or another UE) and report channel state feedback to the network entity (or the other UE), where the channel state feedback is determined based on measurements of the reference signal received at the UE.

FIG. 5 depicts a process flow 500 for closed-loop feedback associated with a communication channel between a network entity 502 and a UE 504.

At 506, UE 504 sends a reference signal (e.g., SSB, CSI-RS, DMRS, PT-RS, SRS, etc.) to the network entity 502. In certain aspects, the UE 504 may send the reference signal (e.g. SRS) using one or more receive antenna ports, which may correspond to an SRS port or SRS antenna port. Transmission of the SRS via the receive antenna port may enable the network entity 502 to deduce the downlink propagation channel associated with the receive antenna port based on channel reciprocity.

At 508, the network entity 502 performs communications performance calculations (e.g., channel calculations) based on the reference signal, such as determining a channel matrix estimate H based on the received reference signal, for example, as further described herein with respect to the UE performing the communications performance calculations at 512. In certain aspects, the network entity 502 may further calculate, as part of the communications performance calculations, a precoder V (e.g., precoder matrix) based on the channel matrix estimate H, for example, as further described herein with respect to the UE 504 performing such a calculation. Accordingly, the network entity 502 may determine H and/or V for an uplink channel between UE 504 and network entity 502 based on SRS. Further, the uplink channel between UE 504 and network entity 502 may have reciprocity with a downlink channel between UE 504 and network entity 502. Accordingly, the determined values of H and/or V for the uplink channel between UE 504 and network entity 502 may be used for the downlink channel between UE 504 and network entity 502. In some cases, the reciprocity between the uplink channel and the downlink channel may be based on a known difference between the uplink channel and the downlink channel, such that the difference can be represented by a function. Accordingly, in certain aspects, to determine H and/or V for the downlink channel, the network entity 502 may apply a function to H and/or V determined for the uplink channel.

At 510, the UE 504 receives a reference signal (e.g., SSB, CSI-RS, etc.) from the network entity 502. In certain aspects, the network entity may send the reference signal with precoding (e.g., beamforming, MIMO layer(s), and/or compensation for signal propagation effects) based on the channel matrix estimate and/or precoder determined at 508.

At 512, the UE 504 performs channel calculations based on the reference signal, such as determining a channel matrix estimate H based on the received reference signal. For example, the UE 504 may include a demodulator or a baseband processor, which may be part of a modem (e.g., the modem(s) 326) of UE 504. The demodulator, such as a component of the modem, may obtain as input the reference signal as received over multiple antennas of the UE 504 and output (or determine) a vector y that is a representation of the received reference signal as received over each of the multiple antennas of the UE 504.

Based on a received signal model, the vector y can be represented as follows in equation (1):

\vec{y}=H\vec{x}+\vec{n} (1)

In equation (1), H corresponds to a matrix representation of the communications channel, as in a channel estimate of the communications channel the signal is communicated in (e.g., downlink communication channel where the reference signal is communicated), \vec{x} is the vector representing symbols transmitted by network entity 502 over a number of spatial layers, and \vec{n} is the additive noise observed with receiving antenna elements. In certain aspects, H has a size equal to the number of antennas used to receive the signaling, Nₐₙₜ, times the number of spatial layers, Nₗ, (e.g., the number of beamformed transmissions, number of antenna ports, etc.). For example, H has a number of rows equal to Nₐₙₜ and a number of columns equal to Nₗ. In certain aspects, the symbols that form the reference signal are known by the UE 504 (e.g., configured or preconfigured at the UE). UE 504 can determine the channel matrix estimate H based on receiving the reference signal.

In certain aspects, UE 504 may further calculate, as part of the calculations, a precoder V (e.g., precoder matrix) based on the channel matrix estimate H. For example, UE 504 may be configured to perform singular value decomposition (SVD) based precoding to determine the precoder V. For example, if the SVD of H leads to H=USV, such that SVD provides the precoder V. U may be related to the ordering of the rows of H, as in the ordering of the antennas as represented by H. It should be understood that other suitable techniques may be used to determine the precoder V based on the channel matrix estimate H.

At 514, UE 504 sends to the network entity 502 a CSI report indicating the determined channel matrix estimate H and/or precoder V. For example, the UE 504 may determine one or more CSI parameters, such as channel quality indicator (CQI), precoding matrix indicator (PMI), and/or rank indicator (RI) based on H and/or V. RI may represent the number of MIMO layers requested by the UE for downlink transmissions. PMI may define a set of indices corresponding to one or more precoding matrices (e.g., the precoding matrix V or a precoding matrix similar to V) to apply to downlink transmissions. In certain aspects, the PMI may indicate the UE's preferred precoding for downlink transmissions on the PDSCH. CQI may be an indicator of the UE's preferred modulation and coding scheme for downlink transmissions. The UE 504 may send an indication of the one or more determined CSI parameters to the network entity 502 in the CSI report. The network entity 502 may schedule downlink data transmissions to the UE 504 accordingly, such as using an MCS, code rate, number of MIMO layers, or the like, that the network entity determines based on the CSI report.

### Aspects Related to Precoding Feedback

In certain aspects, precoding feedback described herein may be indicated via a precoding codebook. A precoding codebook may define the matrix notation for reporting the preferred precoding for one or more beams, for example, in the context of gains and phase shifts applied across antenna elements that form certain beams. Certain wireless communication systems (e.g., 5G NR or any future wireless communication system) may define the precoding codebooks used for precoding feedback. As an example, 5G NR systems may use Type-I codebooks, (enhanced) Type-II codebooks, and (enhanced) Type-II port selection codebooks.

The Type-I codebooks are primarily used for single-user MIMO (SU-MIMO) with support for high and low order MIMO transmissions (e.g., 8×8, 4×4, and 2×2 MIMO). The Type-I codebooks may be used in line-of-sight scenarios for the communication link between the UE and the network entity. The Type-I codebooks may include single panel and multi-panel codebooks, where single panel and multi-panel refer to the transmission panel(s) used at the network entity.

The Type-II codebooks are used for multi-user MIMO (MU-MIMO) with support for up to two MIMO layers. The Type-II codebooks may provide more accurate channel state information with respect to the Type-I codebooks. The Type-II codebooks may include a Type-II codebook, an enhanced Type-II codebook, a Type-II Doppler codebook, and a Type-II coherent joint transmission (CJT) codebook.

The Type-II port selection codebooks are used for obtaining refined precoding feedback with respect to the Type-I and Type-II codebooks. The Type-II port selection codebooks rely on reference signals that have been beamformed at the network entity, for example, where the network entity has some knowledge of the communication channel between the UE and the network entity (e.g., knowledge derived from one of the other precoding codebooks, such as the Type-I and Type-II codebooks). The Type-II port selection codebooks may include a Type-II port selection codebook, an Enhanced Type-II Port Selection codebook, and a Further Enhanced Type-II Port Selection codebook. The Type-II codebooks and the Type-II port selection codebooks may be used in multi-path channels. The Enhanced Type-II Port Selection codebook and the Further Enhanced Type-II Port Selection codebook may be used for spatial and frequency sparsity.

FIG. 6 illustrates a matrix notation 600 of an example precoding feedback codebook, for example, an Enhanced Type-II codebook. The Enhanced Type-II codebook supports up to rank 4 precoding feedback with reduced overhead using a compression technique. In this example, a precoder matrix [symbol] for a particular layer [symbol] may be given by the following expression:

$${W}^{( ℓ )} = {W}_{1} {W}_{2 , ℓ} {W}_{f , ℓ}^{H}$$

where W₁ is a wideband spatial domain (SD) basis (e.g., a beam matrix 602); [symbol] is a coefficient matrix 604 comprising subband phases and subband amplitudes, and

$${W}_{f , ℓ}^{H}$$

is a delay matrix 606 (e.g., a frequency domain (FD) basis) comprising delay information that maps phase information of the N₃ subbands to the M basis vectors. The precoder matrix [symbol] has a size of Nₜ×N₃, where Nₜ is the number of transmit antenna elements (which may include physical or logical antenna elements), N₃ is the number of subbands being reported and determined by a number of CQI subbands and the number of PMI subbands per CQI subband.

The beam matrix 602 (W₁) is a block-diagonal matrix having a size of Nₜ×2L and may be the same for all layers (e.g., layer common), where L is the number of beams being reported and may be configured via control signaling. The coefficient matrix 604 [symbol] has a size of 2L×M and is specific to each layer (e.g., layer specific), where M is the number of basis vectors in the frequency domain. M may be configured via control signaling and based on the rank indicator (RI). The UE may be configured with a parameter (K₀) that defines the maximum number of non-zero coefficients that can be reported across all layers. The delay matrix 606

$$( {W}_{f , ℓ}^{H} )$$

has a size of M×N₃ and is specific to each layer (e.g., layer specific).

One difference between port selection codebooks and non-port selection codebooks (e.g., Type-I codebooks and Type-II codebooks) is in the beam selection mechanisms. In the non-port selection codebooks, the UE indicates spatial beams via CSI feedback, for example, as part of the beam matrix W₁. For example, the UE generates intermediate candidate beams using spatial oversampling between spatially separated orthogonal beams, and the UE may select one or several strong beams among the candidate beams based on the CSI. In port selection codebooks, the network entity transmits precoded reference signals with different precoders, where each precoder represents a particular beam and is associated with an antenna port. The UE selects several antenna ports by measurements of the corresponding reference signals and reports the coefficients. Thus, the beams are determined by antenna port selection. In FR2, the UE may indicate spatial beams during certain beam management operations, and codebooks may generally be thought of as port selection codebooks. Port selection codebooks may provide lower complexity and improved scaling for UE antenna array sizes.

FIG. 7 illustrates an example precoding architecture 700 for communication channels between a network entity 702 and a UE 704. In this example, the network entity 702 may perform precoding 706 (e.g., digital precoding) for beamformed communications. For digital precoding, the network entity 702 may generate different signals having different phases and/or powers in the digital domain for each antenna element to form a beamformed transmission of a precoded signal, which may be associated with a precoding antenna port (e.g., a CSI-RS antenna port) among a pool of precoding antenna ports 708A-N (collectively the precoding antenna ports 708). A precoding antenna port (e.g., the precoding antenna port 708) may correspond to one or more antenna elements used to form a beam (e.g., the transmit beam 714A) on a given communication channel (e.g., H₁) between the network entity 702 and the UE 704.

In certain cases, the network entity 702 may include a plurality of transmission-reception points (TRPs) 710A-N. A TRP may be or include an antenna panel having a plurality of antenna elements 712A-N(collectively the antenna elements 712), for example, arranged in an array. In some cases, the antenna elements 712 may include cross-polar antenna elements. The antenna elements 712 may be used to form various transmit beams 714, where each of the transmit beams 714 may correspond to a specific precoding antenna port among the precoding antenna ports 708. For example, the first precoding antenna port 708A may correspond to the first transmit beam 714A formed via the first TRP 710A, and the nth precoding antenna port 708N may correspond to the nth transmit beam 714N formed via the nth TRP 710N. The UE 704 may receive signals 716 from the network entity 702 via a receive beam 714.

In beam-based operation (e.g., millimeter wave bands), the actual spatial domain basis vectors may not be based on specific discrete Fourier transform (DFT) structures. Depending on the network entity and/or UE implementation, different beam patterns may be used, and these beam patterns may be transparent to the other node. For example, the actual beam weights may not be from a specific DFT dictionary and may not be known to the other node. In this context, Type-II port selection-based codebooks may be used for precoding feedback, where the beam matrix W₁ may have binary entries (e.g., “1” indicating the corresponding port is selected, “0” otherwise).

### Aspects Related to Deployment-Specific Precoding Codebooks

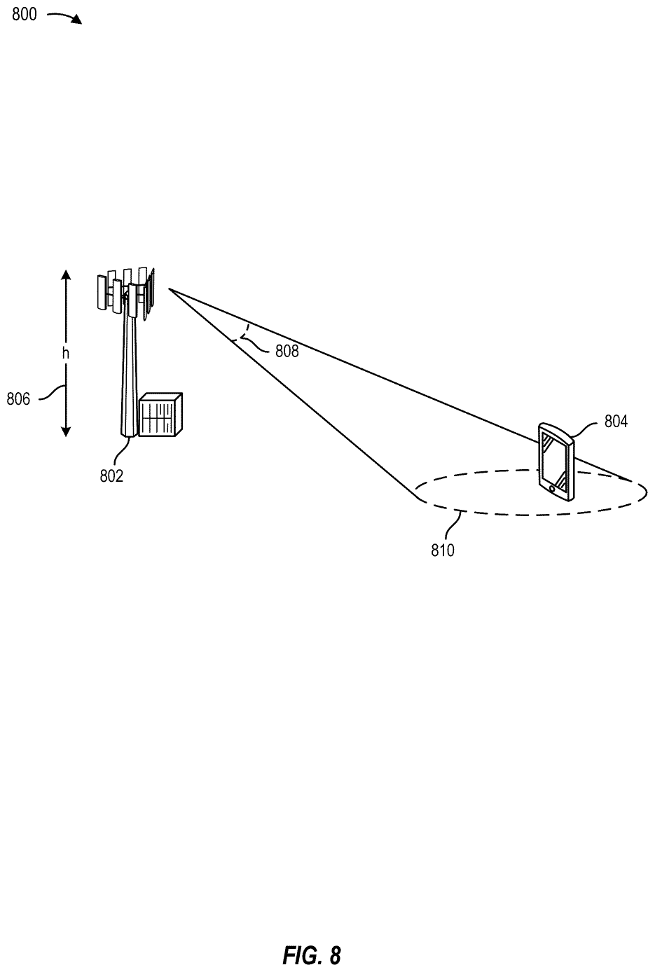

FIG. 8 depicts an example wireless communications network 800 that supports deployment-specific precoding codebooks in accordance with aspects of the present disclosure. In some examples, the wireless communications network 800 may implement aspects of or may be implemented by aspects of FIGS. 1-7. For example, the wireless communications network 800 may include a network entity 802 and a UE 804. The network entity 802 may be an example of the BS 102 depicted and described with respect to FIG. 1, the first network entity 300 or the second network entity 302 depicted and described with respect to FIG. 3, a disaggregated base station depicted and described with respect to FIG. 2, the network entity 502 depicted and described with respect to FIG. 5, or the network entity 702 depicted and described with respect to FIG. 7. The UE 804 may be an example of the UE 104 depicted and described with respect to FIG. 1, the UE 304 depicted and described with respect to FIG. 3, the UE 504 depicted and described with respect to FIG. 5, or the UE 704 depicted and described with respect to FIG. 7.

In some aspects, the UE 804 may be configured to provide channel state feedback to the network entity 802 as depicted and described with respect to FIG. 5. For example, as part of the channel state feedback, the UE 804 may indicate a preferred precoder (e.g., via a PMI) to be used for subsequent communications (e.g., as described with respect to FIGS. 6 and 7). In some cases, the UE 804 may select the preferred precoder from a precoding codebook that is predefined in wireless communications standards, where the precoding codebook is indicated by the network entity 802 via a configuration message for the channel state feedback. However, the precoding codebook predefined in the wireless communications standards may be configured for generic environments and communication deployments, such that the predefined precoding codebook may not be ideal for a specific environment or communication deployment of the network entity 802.

As an example, the network entity 802 may be at a height (h) 806, where a specific angle 808 for communications from the network entity 802 (e.g., via beamformed communications) based on the height 806 may be desired to serve a corresponding coverage area 810 (e.g., an example of the coverage area 110 depicted and described with respect to FIG. 1). In some cases, the predefined precoding codebook(s) from the wireless communications standards may not be configured to enable the network entity 802 to communicate at the specific angle 808, though. For example, the predefined precoding codebook(s) may not include precoders that enable the network entity 802 to send communications at the specific angle 808, such as gains, phase shifts, and/or beamforming weights that the network entity 802 can apply across transmit antenna elements of the network entity 802 to communicate at the specific angle 808 and serve the coverage area 810.

Accordingly, as described herein, the network entity 802 may use a deployment-specific precoding codebook to communicate with the UE 804, where the deployment-specific precoding codebook may enable the network entity 802 to communicate based on specific environments or communication deployments of the network entity 802. For example, the deployment-specific precoding codebook may include a beamforming codebook that enables the network entity 802 to configure certain beams at the specific angle 808 and serve the coverage area 810 more accurately than the predefined precoding codebooks from the wireless communications standards. That is, the deployment-specific precoding codebook may include multiple precoders that support beamformed communications that can be sent at the specific angle 808. In some aspects, the deployment-specific precoding codebook may be referred to as a proprietary precoding codebook (e.g., a precoding codebook that is configured and/or owned by a specific wireless communications provider, such as a wireless communications provider that owns and operates the network entity 802).

The deployment-specific precoding codebooks may be useful for different environments, settings, and/or deployments of the network entity 802. For example, the network entity 802 may be located in a rural macrocell (RMa) setting (e.g., the network entity 802 provides cellular coverage over a wide area in a rural environment) with tree coverage that could impact and/or interfere with beamformed communications from the network entity 802. Alternatively, the network entity 802 may be located in a dense suburban setting with a high amount of high-rise buildings that have a higher impact and/or cause a higher amount of interference with beamformed communications from the network entity 802. As such, a precoding codebook that is useful for the RMa setting may not have a bearing in terms of efficacy in the dense suburban setting, and deployment-specific precoding codebooks may provide better coverage in one or both of the settings compared to predefined precoding codebooks.

Additionally or alternatively, the network entity 802 may be located within a building setting or environment, where the building includes multiple tiers, levels, or floors, such as a shopping mall and/or sports stadium. As such, the deployment-specific precoding codebook may support communications for different elevation coverages based on the multiple tiers, levels, or floors within the building, which may not be needed if the network entity 802 is located in an urban macrocell (UMa) setting (e.g., the network entity 802 provides cellular coverage over a wide area in an urban environment, such as along highways or on rooftop levels of buildings).

In some aspects, the network entity 802 may dynamically update a precoding codebook based on digital twin model(s) (e.g., virtual representation(s) of communications for the network entity 802, such as a testing environment) or other sensing techniques. For example, the network entity 802 may detect a significant environment change that could impact and/or interfere with communications from the network entity 802. As an example, the network entity 802 may detect a large truck is parked within a coverage area for the network entity 802 and/or another physical object that affect and/or impedes beamformed communications from the network entity 802. Accordingly, the network entity 802 may use deployment-specific codebooks and/or indicate updates to the deployment-specific codebooks to corresponding UEs (e.g., the UE 804) to mitigate the effects of the detected significant environment change.

Additionally or alternatively, the network entity 802 may employ AI/ML models for generating precoding codebooks. That is, the network entity 802 may employ the AI/ML models to deviate from the precoding codebooks predefined in the wireless communications standards that work for generic environments to generate and/or optimize the precoding codebooks for specific deployments or environments (e.g., deployment-specific precoding codebooks). As such, the deployment-specific precoding codebooks may enable the network entity 802 to indicate deviations from the predefined precoding codebooks obtained from the AI/ML models to UEs.

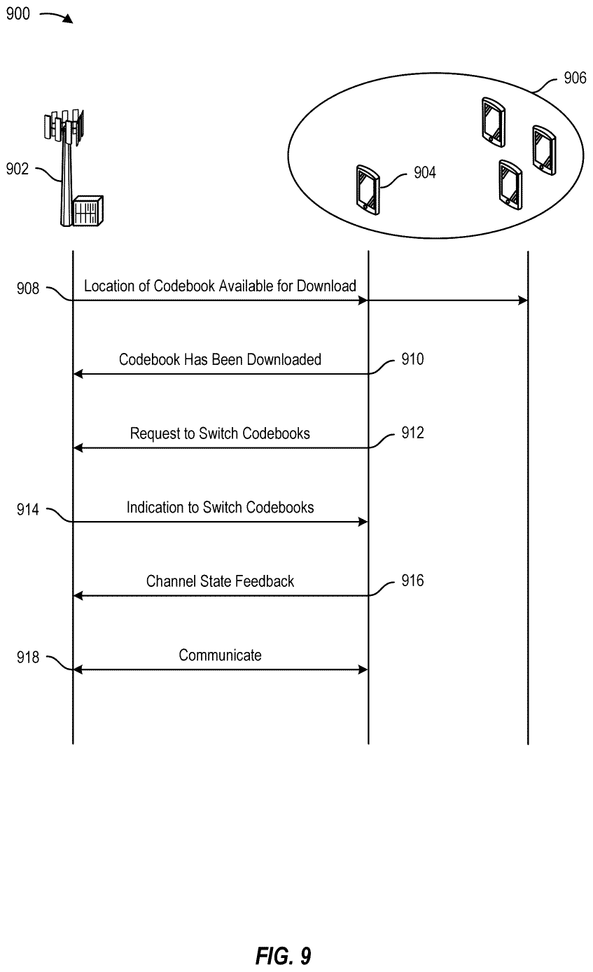

In some aspects, the use of deployment-specific codebooks may be up to network implementation (e.g., determined to be used or not by the network entity 802). However, in some cases, the use of such deployment-specific codebooks may not be supported by UEs. For example, a UE may not be configured to indicate a preferred precoder from the deployment-specific precoding codebook, so the use of a precoder from the deployment-specific precoding codebook may not be implicitly assumed at the UE. Accordingly, as described in greater detail with respect to FIG. 9, signaling is defined to enable the use of precoders from a deployment-specific precoding codebook at the network entity 802.

### Example Signaling of Deployment-Specific Precoding Codebooks

FIG. 9 depicts a process flow 900 for communications in a network between a network entity 902 and at least a UE 904. In some aspects, the network entity 902 may be an example of the BS 102 depicted and described with respect to FIG. 1, the first network entity 300 or the second network entity 302 depicted and described with respect to FIG. 3, a disaggregated base station depicted and described with respect to FIG. 2, the network entity 502 depicted and described with respect to FIG. 5, the network entity 702 depicted and described with respect to FIG. 7, or the network entity 802 depicted and described with respect to FIG. 8. Similarly, the UE 904 may be an example of the UE 104 depicted and described with respect to FIG. 1, the UE 304 depicted and described with respect to FIG. 3, the UE 504 depicted and described with respect to FIG. 5, the UE 704 depicted and described with respect to FIG. 7, or the UE 804 depicted and described with respect to FIG. 8. However, in other aspects, UE 904 may be another type of wireless communications device and network entity 902 may be another type of network entity or network node, such as those described herein. Note that any operations or signaling illustrated with dashed lines may indicate that that operation or signaling is an optional or alternative example.

At 908, the network entity 902 sends a first message that indicates a (virtual) location corresponding to a codebook available for download, where the codebook may be configured based on deployment parameters that are specific for communications with the network entity 902 (e.g., a deployment-specific precoding codebook). For example, the network entity 902 may broadcast the first message to a group of UEs 906 that includes the UE 904. In some aspects, the network entity 902 may broadcast the first message during a cell acquisition phase. That is, during the cell acquisition phase, the network entity 902 may provide information to the group of UEs 906 as to the location where a deployment-specific precoding codebook can be downloaded. Accordingly, to obtain the first message, the UE 904 may obtain the first message in a broadcast during an initial cell acquisition phase. In some aspects, the location may include a public database (e.g., online database) that stores one or more codebooks (e.g., one or more deployment-specific precoding codebooks and/or other codebooks configured by the network entity 902), where the one or more codebooks include the codebook indicated by the first message. Additionally or alternatively, the location may include a resource in the Internet where the codebook is available for download, such as a virtual location with an IP address. In certain aspects, the indication of the location may include a uniform resource locator (URL).

In some aspects, the first message may also indicate or include information for how the group of UEs 906 are to interpret and/or convey channel state feedback based on the codebook indicated in the first message. For example, the first message may indicate how the group of UEs 906 are to interpret and/or convey PMI, RI, and CQI associated with each precoder that can be selected from the codebook indicated in the first message. In certain aspects, the codebook indicated in the first message may include multiple precoders, and the location that stores the codebook (e.g., a public database) may also include indications of mechanisms for transmission of channel state feedback for each precoder of the multiple precoders. To use the codebook indicated in the first message, a UE may include a capability to support a CSI framework based on deployment-specific precoding codebooks and/or proprietary precoding codebooks. For example, to obtain the first message, the UE 904 may obtain the first message based on a capability of the UE 904 to support usage of the codebook available for download. In some aspects, signaling overhead may be decreased by using the first message to indicate the location corresponding to the codebook available for download rather than sending the codebook itself to the group of UEs 906, where the codebook may include UE-specific codebook(s).

At 910, the UE 904 sends and the network entity 902 obtains an indication that the codebook has been downloaded by the UE 904 according to the location indicated in the first message. That is, the UE 904 may indicate that the UE 904 has downloaded the codebook indicated in the first message (e.g., the deployment-specific precoding codebook) and is ready to use the codebook.

At 912, the UE 904 sends and the network entity 902 obtains a request to switch to the codebook for communications with the network entity 902. For example, the UE 904 may communicate with the network entity 902 based on a preconfigured codebook (e.g., predefined in the wireless communications standards as described previously) prior to communications with the network entity 902 based on the codebook and prior to the request to switch to the codebook. Accordingly, the request to switch to the codebook may be sent based on communicating with the network entity 902 based on the preconfigured codebook, where the communications with the network entity 902 based on the preconfigured codebook may have low performance (e.g., as determined from channel state feedback and/or measurements performed by the UE 904 for the communications based on the preconfigured codebook). In some aspects, the UE 904 may send the request to switch to the codebook for communications with the network entity 902 based on requirements and/or use-cases of communications between the UE 904 and the network entity 902.

At 914, the network entity 902 sends and the UE 904 obtains a second message that indicates to use the codebook for communications with the network entity 902. For example, the network entity 902 may trigger usage of the codebook for the UE 904 to communicate with the network entity 902 based on obtaining the request to switch to the codebook from the UE 904. In some aspects, the network entity 902 may trigger usage of the codebook for the UE 904 to communicate with the network entity 902 via the second message based on the UE 904 having already established a communication link with the network entity 902. That is, the UE 904 may establish a communication link with the network entity 902, and the second message may be communicated from the network entity 902 to the UE 904 based on the communication link being established. In some aspects, the second message may include an RRC message that is configured to indicate the use of the codebook or not (e.g., a Codebook_Deployment_Specific RRC message). For example, the RRC message may include two possible values, such as a first value (e.g., ‘1’) that indicates the usage of the codebook indicated in the first message (e.g., the deployment-specific precoding codebook) or a second value (e.g., ‘0’) that indicates the usage of preconfigured codebooks (e.g., predefined codebooks in wireless communications standards). In some aspects, to support the use of the codebook indicated in the first message, the UE 904 may be in low mobility conditions (e.g., not moving or being stationary for a certain amount of time) to allow for the UE 904 to search for a precoder from the codebook.

At 916, the UE 904 sends and the network entity 902 obtains channel state feedback (e.g., a CSI report) based on the codebook. For example, the UE 904 may indicate a PMI, RI and CQI from the codebook in the channel state feedback. In some aspects, the UE 904 may estimate a channel matrix from the network entity 902 (e.g., based on measurements of reference signals sent by the network entity 902). Subsequently, using this information of the estimated channel matrix, the UE 904 may search over all the precoders in the codebook for optimal performance and may determine a combiner for use in correspondence with the optimal precoder. Accordingly, the UE 904 may then indicate the precoder selected from the codebook to the network entity 902 using a message protocol indicated in the first message (e.g., how the UE 904 is to interpret and/or convey PMI, RI, and CQI associated with each precoder that can be selected from the codebook indicated in the first message). That is, the codebook may include multiple precoders of different ranks and associated MCSs, and the channel state feedback sent by the UE 904 may include an indication of a rank and a precoder selected from the multiple precoders and an associated MCS to be used with the selected precoder.

At 918, the UE 904 and the network entity 902 communicate based on the codebook. For example, the network entity 902 and the UE 904 may establish an enhanced communication link using the indicated precoder and combiner from the channel state feedback. That is, the UE 904 may communicate with the network entity 902 based on the selected precoder and a combiner that corresponds to the selected precoder.

In some aspects, the use of deployment-specific precoding codebooks may be extended to the UE 904. For example, the UE 904 may consider a deployment-specific precoding codebook and/or proprietary codebook at its end for performance enhancement. That is, knowing the location of the UE 904 and the specific environment in which the UE 904 is deployed, the network entity 902 may optimize the codebook to be used at the UE 904. This knowledge may be based on digital twin models or may come from crowd-sourcing information from experiences and communications from other UEs (e.g., from the group of UEs 906).

Note that the process flow illustrated in FIG. 9 is an example of usage of precoding codebooks, and aspects of the present disclosure may be applied to deployment-specific precoding codebooks. Note that the process flow illustrated in FIG. 9 is described herein to facilitate an understanding of signaling to implement the use of deployment-specific precoding codebooks, and aspects of the present disclosure may be performed in various manners via alternative or additional signaling and/or operations. In certain aspects, the operations and/or signaling of FIG. 9 may occur in an order different from that described or depicted, and various actions, operations, and/or signaling may be added, omitted, or combined.

### Example Operations of a User Equipment

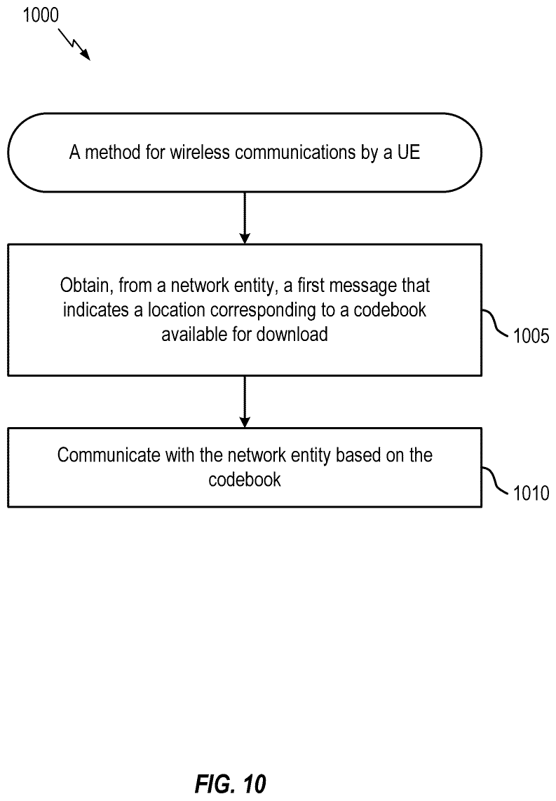

FIG. 10 shows a method 1000 for wireless communications by a UE, such as UE 104 of FIG. 1 or UE 304 of FIG. 3.

Method 1000 begins at block 1005 with obtaining, from a network entity, a first message (e.g., the first message communicated at 908 as depicted and described with respect to FIG. 9) that indicates a location corresponding to a codebook available for download.

Method 1000 then proceeds to block 1010 with communicating with the network entity based on the codebook (e.g., the communications at 918 as depicted and described with respect to FIG. 9).

In some aspects, method 1000 further includes sending, to the network entity, an indication that the codebook has been downloaded according to the location indicated in the first message (e.g., the indication communicated at 910 as depicted and described with respect to FIG. 9).

In some aspects, method 1000 further includes sending, to the network entity, a request to switch to the codebook for communications with the network entity (e.g., the request to switch communicated at 912 as depicted and described with respect to FIG. 9).

In some aspects, method 1000 further includes communicating with the network entity based on a preconfigured codebook prior to communications with the network entity based on the codebook, wherein the request to switch to the codebook is sent based on communicating with the network entity based on the preconfigured codebook.

In some aspects, method 1000 further includes obtaining, from the network entity, a second message that indicates to use the codebook for communications with the network entity (e.g., the second message communicated at 914 as depicted and described with respect to FIG. 9).

In some aspects, method 1000 further includes establishing a communication link with the network entity, wherein the second message is obtained based on the communication link being established.

In some aspects, the second message comprises a RRC message.

In some aspects, method 1000 further includes sending, to the network entity, channel state feedback based on the codebook (e.g., the channel state feedback communicated at 916 as depicted and described with respect to FIG. 9).

In some aspects, the codebook comprises a plurality of precoders of different ranks and associated MCSs, the channel state feedback comprises an indication of a rank and a precoder selected from the plurality of precoders and an associated MCS to be used with the selected precoder.

In some aspects, block 1010 includes communicating with the network entity based on the selected precoder and a combiner that corresponds to the selected precoder.

In some aspects, the channel state feedback comprises one or more of: a PMI, a RI, or a CQI.

In some aspects, the location corresponding to the codebook available for download comprises a public database that stores one or more codebooks, and the one or more codebooks comprise the codebook.

In some aspects, the codebook comprises a plurality of precoders, and the public database stores indications of mechanisms for transmission of channel state feedback for each precoder of the plurality of precoders.

In some aspects, the codebook is configured based on deployment parameters that are specific for communications with the network entity.

In some aspects, block 1005 includes obtaining the first message in a broadcast during an initial cell acquisition phase.

In some aspects, block 1005 includes obtaining the first message based on a capability of the UE to support usage of the codebook available for download.

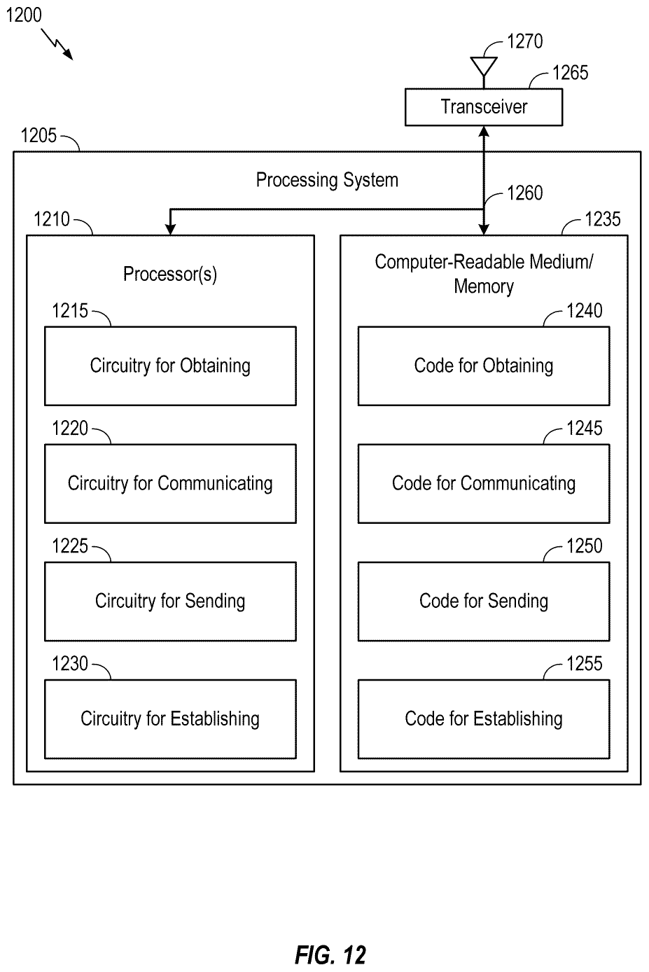

In some aspects, method 1000, or any aspect related to it, may be performed by an apparatus, such as communications device 1200 of FIG. 12, which includes various components operable, configured, or adapted to perform the method 1000. Communications device 1200 is described below in further detail.

Note that FIG. 10 is just one example of a method, and other methods including fewer, additional, or alternative operations are possible consistent with this disclosure.

In certain aspects, method 1000 may be performed by the apparatus to realize one or more technical effects or solutions to the aforementioned technical problem(s). For example, deployment-specific precoding codebooks for communications between a network entity and the apparatus described herein may provide beneficial technical effects and/or advantages. In some aspects, the techniques for using deployment-specific precoding codebooks may enable improved wireless communications performance, such as increased reliability and increased throughput. For example, the deployment-specific precoding codebooks may be defined and used for specific communication scenarios and environments for the network entity (e.g., deployments of the network entity) as opposed to the generic environments for which precoding codebooks are predefined in wireless communications standards. As such, the deployment-specific precoding codebooks may take into consideration the specific communication scenarios and environments for the network entity, thereby increasing reliability and throughput for communications between the network entity and UEs, such as using specific angles and/or coverage regions based on the deployment-specific precoding codebooks to more accurately serve UEs in the specific communication scenarios and environments for the network entity.

### Example Operations of a Network Entity

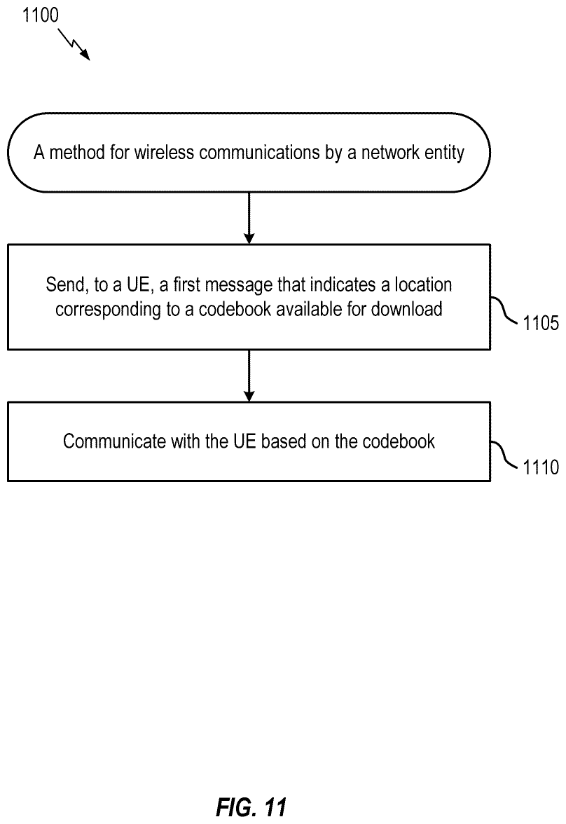

FIG. 11 shows a method 1100 for wireless communications by a network entity, such as BS 102 of FIG. 1, a first network entity 300 or second network entity 302 of FIG. 3, or a disaggregated base station as discussed with respect to FIG. 2.

Method 1100 begins at block 1105 with sending, to a UE, a first message (e.g., the first message communicated at 908 as depicted and described with respect to FIG. 9) that indicates a location corresponding to a codebook available for download.

Method 1100 then proceeds to block 1110 with communicating with the UE based on the codebook (e.g., the communications at 918 as depicted and described with respect to FIG. 9).

In certain aspects, method 1100 further includes obtaining, from the UE, an indication that the codebook has been downloaded according to the location indicated in the first message (e.g., the indication communicated at 910 as depicted and described with respect to FIG. 9).

In certain aspects, method 1100 further includes obtaining, from the UE, a request to switch to the codebook for communications with the UE (e.g., the request to switch communicated at 912 as depicted and described with respect to FIG. 9).

In certain aspects, method 1100 further includes communicating with the UE based on a preconfigured codebook prior to communications with the UE based on the codebook, wherein the request to switch to the codebook is obtained based on communicating with the UE based on the preconfigured codebook.

In certain aspects, method 1100 further includes sending, to the UE, a second message that indicates to use the codebook for communications with the network entity (e.g., the second message communicated at 914 as depicted and described with respect to FIG. 9).

In certain aspects, method 1100 further includes establishing a communication link with the UE, wherein the second message is sent based on the communication link being established.

In some aspects, the second message comprises a RRC message.

In certain aspects, method 1100 further includes obtaining, from the UE, channel state feedback based on the codebook (e.g., the channel state feedback communicated at 916 as depicted and described with respect to FIG. 9).

In some aspects, the codebook comprises a plurality of precoders of different ranks and associated MCSs, the channel state feedback comprises an indication of a rank and a precoder selected from the plurality of precoders and an associated MCS to be used with the selected precoder.

In some aspects, block 1110 includes communicating with the UE based on the selected precoder and a combiner that corresponds to the selected precoder.

In some aspects, the channel state feedback comprises one or more of: a PMI, a RI, or a CQI.

In some aspects, the location corresponding to the codebook available for download comprises a public database that stores one or more codebooks, and the one or more codebooks comprise the codebook.

In some aspects, the codebook comprises a plurality of precoders, and the public database stores indications of mechanisms for transmission of channel state feedback for each precoder of the plurality of precoders.

In some aspects, the codebook is configured based on deployment parameters that are specific for communications with the network entity.

In some aspects, block 1105 includes sending the first message in a broadcast during an initial cell acquisition phase.

In some aspects, block 1105 includes sending the first message based on a capability of the UE to support usage of the codebook available for download.

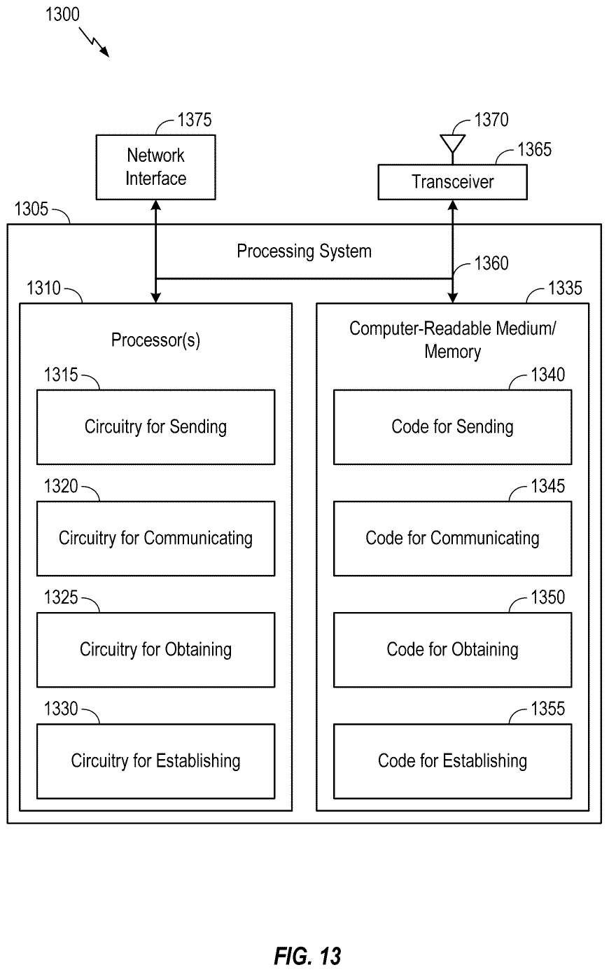

In some aspects, method 1100, or any aspect related to it, may be performed by an apparatus, such as communications device 1300 of FIG. 13, which includes various components operable, configured, or adapted to perform the method 1100. Communications device 1300 is described below in further detail.

Note that FIG. 11 is just one example of a method, and other methods including fewer, additional, or alternative operations are possible consistent with this disclosure.

In certain aspects, method 1100 may be performed by the apparatus to realize one or more technical effects or solutions to the aforementioned technical problem(s). For example, deployment-specific precoding codebooks for communications between the apparatus and a UE described herein may provide beneficial technical effects and/or advantages. In some aspects, the techniques for using deployment-specific precoding codebooks may enable improved wireless communications performance, such as increased reliability and increased throughput. For example, the deployment-specific precoding codebooks may be defined and used for specific communication scenarios and environments for the network entity (e.g., deployments of the network entity) as opposed to the generic environments for which precoding codebooks are predefined in wireless communications standards. As such, the deployment-specific precoding codebooks may take into consideration the specific communication scenarios and environments for the network entity, thereby increasing reliability and throughput for communications between the network entity and UEs, such as using specific angles and/or coverage regions based on the deployment-specific precoding codebooks to more accurately serve UEs in the specific communication scenarios and environments for the network entity.

### Example Communications Devices

FIG. 12 depicts aspects of an example communications device 1200 configured for wireless communications. In some aspects, communications device 1200 is a user equipment, such as UE 104 described above with respect to FIG. 1 or UE 304 described with respect to FIG. 3.

The communications device 1200 includes a processing system 1205 coupled to a transceiver 1265 (e.g., a transmitter and/or a receiver). The transceiver 1265 is configured to transmit and receive signals for the communications device 1200 via an antenna 1270, such as the various signals as described herein. The processing system 1205 may be configured to perform processing functions for the communications device 1200, including processing signals received and/or to be transmitted by the communications device 1200.

The processing system 1205 includes one or more processors 1210 and a computer-readable medium/memory 1235. In various aspects, the one or more processors 1210 may be representative of the one or more processors 318 described with respect to FIG. 3. The one or more processors 1210 are coupled to a computer-readable medium/memory 1235 via a bus 1260. In some aspects, the computer-readable medium/memory 1235 may be representative of the one or more memories 320 described with respect to FIG. 3. The computer-readable medium/memory 1235 is a non-transitory computer-readable medium/memory. In certain aspects, the computer-readable medium/memory 1235 is configured to store instructions (e.g., computer-executable code), that when executed by the one or more processors 1210, cause the one or more processors 1210 to perform the method 1000 described with respect to FIG. 10, or any aspect related to it, including any operations described in relation to FIG. 10. Note that reference to a processor performing a function of communications device 1200 may include one or more processors performing that function of communications device 1200, such as in a distributed fashion.

In the depicted example, computer-readable medium/memory 1235 stores code (e.g., executable instructions), including code for obtaining 1240, code for communicating 1245, code for sending 1250, and code for establishing 1255. Processing of the code 1240-1255 may enable and cause the communications device 1200 to perform the method 1000 described with respect to FIG. 10, or any aspect related to it. For instance, in some aspects, code for obtaining 1240 includes code for obtaining, from a network entity, a first message that indicates a location corresponding to a codebook available for download. In some aspects, code for communicating 1245 includes code for communicating with the network entity based on the codebook.

The one or more processors 1210 include circuitry configured to implement (e.g., execute) the code stored in the computer-readable medium/memory 1235, including circuitry for obtaining 1215, circuitry for communicating 1220, circuitry for sending 1225, and circuitry for establishing 1230. Processing with circuitry 1215-1230 may enable and cause the communications device 1200 to perform the method 1000 described with respect to FIG. 10, or any aspect related to it. For instance, in some aspects, circuitry for obtaining 1215 includes circuitry for obtaining, from a network entity, a first message that indicates a location corresponding to a codebook available for download. In some aspects, circuitry for communicating 1220 includes circuitry for communicating with the network entity based on the codebook.

More generally, means for communicating, transmitting, sending or outputting for transmission may include the one or more transceivers 324, one or more antenna 322 and/or processing system 316 of the UE 304 illustrated in FIG. 3, transceiver 1265 and/or antenna 1270 of the communications device 1200 in FIG. 12, and/or one or more processors 1210 of the communications device 1200 in FIG. 12. Means for communicating, receiving or obtaining may include the one or more transceivers 324, one or more antennas 322, and/or processing system 316 of the UE 304 illustrated in FIG. 3, transceiver 1265 and/or antenna 1270 of the communications device 1200 in FIG. 12, and/or one or more processors 1210 of the communications device 1200 in FIG. 12.

FIG. 13 depicts aspects of an example communications device configured for wireless communications. In some aspects, communications device 1300 is a network entity, such as BS 102 of FIG. 1, first network entity 300 or second network entity 302 of FIG. 3, or a disaggregated base station as discussed with respect to FIG. 2.

The communications device 1300 includes a processing system 1305 coupled to a transceiver 1365 (e.g., a transmitter and/or a receiver) and/or a network interface 1375. The transceiver 1365 is configured to transmit and receive signals for the communications device 1300 via an antenna 1370, such as the various signals as described herein. The network interface 1375 is configured to obtain and send signals for the communications device 1300 via communications link(s), such as a backhaul link, midhaul link, and/or fronthaul link as described herein, such as with respect to FIG. 2. The processing system 1305 may be configured to perform processing functions for the communications device 1300, including processing signals received and/or to be transmitted by the communications device 1300.

The processing system 1305 includes one or more processors 1310 and a computer-readable medium/memory 1335. In various aspects, one or more processors 1310 may be representative of the one or more processors 308, as described with respect to FIG. 3. The one or more processors 1310 are coupled to the computer-readable medium/memory 1335 via a bus 1360. In certain aspects, the computer-readable medium/memory 1335 is configured to store instructions (e.g., computer-executable code), including code 1340-1355, that when executed by the one or more processors 1310, cause the one or more processors 1310 to perform the method 1100 described with respect to FIG. 11, or any aspect related to it, including any operations described in relation to FIG. 11. The computer-readable medium/memory 1335 is a non-transitory computer-readable medium/memory. Note that reference to a processor of communications device 1300 performing a function may include one or more processors of communications device 1300 performing that function, such as in a distributed fashion.

In the depicted example, the computer-readable medium/memory 1335 stores code (e.g., executable instructions), including code for sending 1340, code for communicating 1345, code for obtaining 1350, and code for establishing 1355. Processing of the code 1340-1355 may enable and cause the communications device 1300 to perform the method 1100 described with respect to FIG. 11, or any aspect related to it. For instance, in some aspects, code for sending 1340 includes code for sending, to a UE, a first message that indicates a location corresponding to a codebook available for download. In some aspects, code for communicating 1345 includes code for communicating with the UE based on the codebook.

The one or more processors 1310 include circuitry configured to implement (e.g., execute) the code stored in the computer-readable medium/memory 1335, including circuitry for sending 1315, circuitry for communicating 1320, circuitry for obtaining 1325, and circuitry for establishing 1330. Processing with circuitry 1315-1330 may enable and cause the communications device 1300 to perform the method 1100 described with respect to FIG. 11, or any aspect related to it. For instance, in some aspects, circuitry for sending 1315 includes circuitry for sending, to a UE, a first message that indicates a location corresponding to a codebook available for download. In some aspects, circuitry for communicating 1320 includes circuitry for communicating with the UE based on the codebook.

Various components of the communications device 1300 may provide means for performing the method 1100 described with respect to FIG. 11, or any aspect related to it. Means for communicating, transmitting, sending or outputting for transmission may include the one or more transceivers 312, one or more antennas 314, and/or processing system 306 of the first network entity 300 or the second network entity 302 illustrated in FIG. 3, transceiver 1365, antenna 1370, and/or network interface 1375 of the communications device 1300 in FIG. 13, and/or one or more processors 1310 of the communications device 1300 in FIG. 13. Means for communicating, receiving or obtaining may include the one or more transceivers 312, one or more antennas 314, and/or processing system 306 of the first network entity 300 or the second network entity 302 illustrated in FIG. 3, transceiver 1365, antenna 1370, and/or network interface 1375 of the communications device 1300 in FIG. 13, and/or one or more processors 1310 of the communications device 1300 in FIG. 13.

### EXAMPLE CLAUSES

Implementation examples are described in the following numbered clauses:
Clause 1: A method for wireless communications by a UE comprising: obtaining, from a network entity, a first message that indicates a location corresponding to a codebook available for download; and communicating with the network entity based on the codebook.
Clause 2: The method of Clause 1, further comprising sending, to the network entity, an indication that the codebook has been downloaded according to the location indicated in the first message.
Clause 3: The method of any one of Clauses 1-2, further comprising sending, to the network entity, a request to switch to the codebook for communications with the network entity.
Clause 4: The method of Clause 3, further comprising communicating with the network entity based on a preconfigured codebook prior to communications with the network entity based on the codebook, wherein the request to switch to the codebook is sent based on communicating with the network entity based on the preconfigured codebook.
Clause 5: The method of any one of Clauses 1-4, further comprising obtaining, from the network entity, a second message that indicates to use the codebook for communications with the network entity.
Clause 6: The method of Clause 5, further comprising establishing a communication link with the network entity, wherein the second message is obtained based on the communication link being established.
Clause 7: The method of Clause 5, wherein the second message comprises a RRC message.
Clause 8: The method of any one of Clauses 1-7, further comprising sending, to the network entity, channel state feedback based on the codebook.
Clause 9: The method of Clause 8, wherein: the codebook comprises a plurality of precoders of different ranks and associated MCSs, the channel state feedback comprises an indication of a rank and a precoder selected from the plurality of precoders and an associated MCS to be used with the selected precoder.
Clause 10: The method of Clause 9, wherein communicating with the network entity comprises communicating with the network entity based on the selected precoder and a combiner that corresponds to the selected precoder.
Clause 11: The method of Clause 8, wherein the channel state feedback comprises one or more of: a PMI, a RI, or a CQI.
Clause 12: The method of any one of Clauses 1-11, wherein: the location corresponding to the codebook available for download comprises a public database that stores one or more codebooks, and the one or more codebooks comprise the codebook.
Clause 13: The method of Clause 12, wherein: the codebook comprises a plurality of precoders, and the public database stores indications of mechanisms for transmission of channel state feedback for each precoder of the plurality of precoders.
Clause 14: The method of any one of Clauses 1-13, wherein the codebook is configured based on deployment parameters that are specific for communications with the network entity.
Clause 15: The method of any one of Clauses 1-14, wherein obtaining the first message comprises obtaining the first message in a broadcast during an initial cell acquisition phase.
Clause 16: The method of any one of Clauses 1-15, wherein obtaining the first message comprises obtaining the first message based on a capability of the UE to support usage of the codebook available for download.
Clause 17: A method for wireless communications by a network entity comprising: sending, to a UE, a first message that indicates a location corresponding to a codebook available for download; and communicating with the UE based on the codebook.
Clause 18: The method of Clause 17, further comprising obtaining, from the UE, an indication that the codebook has been downloaded according to the location indicated in the first message.
Clause 19: The method of any one of Clauses 17-18, further comprising obtaining, from the UE, a request to switch to the codebook for communications with the UE.
Clause 20: The method of Clause 19, further comprising communicating with the UE based on a preconfigured codebook prior to communications with the UE based on the codebook, wherein the request to switch to the codebook is obtained based on communicating with the UE based on the preconfigured codebook.
Clause 21: The method of any one of Clauses 17-20, further comprising sending, to the UE, a second message that indicates to use the codebook for communications with the network entity.
Clause 22: The method of Clause 21, further comprising establishing a communication link with the UE, wherein the second message is sent based on the communication link being established.
Clause 23: The method of Clause 21, wherein the second message comprises a RRC message.
Clause 24: The method of any one of Clauses 17-23, further comprising obtaining, from the UE, channel state feedback based on the codebook.
Clause 25: The method of Clause 24, wherein: the codebook comprises a plurality of precoders of different ranks and associated MCSs, the channel state feedback comprises an indication of a rank and a precoder selected from the plurality of precoders and an associated MCS to be used with the selected precoder.
Clause 26: The method of Clause 25, wherein communicating with the UE comprises communicating with the UE based on the selected precoder and a combiner that corresponds to the selected precoder.
Clause 27: The method of Clause 24, wherein the channel state feedback comprises one or more of: a PMI, a RI, or a CQI.
Clause 28: The method of any one of Clauses 17-27, wherein: the location corresponding to the codebook available for download comprises a public database that stores one or more codebooks, and the one or more codebooks comprise the codebook.
Clause 29: The method of Clause 28, wherein: the codebook comprises a plurality of precoders, and the public database stores indications of mechanisms for transmission of channel state feedback for each precoder of the plurality of precoders.
Clause 30: The method of any one of Clauses 17-29, wherein the codebook is configured based on deployment parameters that are specific for communications with the network entity.
Clause 31: The method of any one of Clauses 17-30, wherein sending the first message comprises sending the first message in a broadcast during an initial cell acquisition phase.
Clause 32: The method of any one of Clauses 17-31, wherein sending the first message comprises sending the first message based on a capability of the UE to support usage of the codebook available for download.
Clause 33: One or more apparatuses, comprising: one or more memories comprising executable instructions; and one or more processors configured to execute the executable instructions and cause the one or more apparatuses to perform a method in accordance with any one of Clauses 1-32.
Clause 34: One or more apparatuses configured for wireless communications, comprising: one or more memories; and one or more processors, coupled to the one or more memories, configured to cause the one or more apparatuses to perform a method in accordance with any one of Clauses 1-32.
Clause 35: One or more apparatuses configured for wireless communications, comprising: one or more memories; and one or more processors, coupled to the one or more memories, configured to perform a method in accordance with any one of Clauses 1-32.
Clause 36: One or more apparatuses, comprising means for performing a method in accordance with any one of Clauses 1-32.
Clause 37: One or more non-transitory computer-readable media comprising executable instructions that, when executed by one or more processors of one or more apparatuses, cause the one or more apparatuses to perform a method in accordance with any one of Clauses 1-32.
Clause 38: One or more computer program products embodied on one or more computer-readable storage media comprising code for performing a method in accordance with any one of Clauses 1-32.
Clause 39: One or more apparatuses configured for wireless communications, comprising: a processing system that includes one or more processors and one or more memories coupled with the one or more processors, the processing system configured to cause the one or more apparatuses to perform a method in accordance with any one of Clauses 1-32.

### Additional Considerations

The preceding description is provided to enable any person skilled in the art to practice the various aspects described herein. The examples discussed herein are not limiting of the scope, applicability, or aspects set forth in the claims. Various modifications to these aspects will be readily apparent to those skilled in the art, and the general principles defined herein may be applied to other aspects. For example, changes may be made in the function and arrangement of elements discussed without departing from the scope of the disclosure. Various examples may omit, substitute, or add various procedures or components as appropriate. For instance, the methods described may be performed in an order different from that described, and various actions may be added, omitted, or combined. Also, features described with respect to some examples may be combined in some other examples. For example, an apparatus may be implemented or a method may be practiced using any number of the aspects set forth herein. In addition, the scope of the disclosure is intended to cover such an apparatus or method that is practiced using other structure, functionality, or structure and functionality in addition to, or other than, the various aspects of the disclosure set forth herein. It should be understood that any aspect of the disclosure disclosed herein may be embodied by one or more elements of a claim.

The various illustrative logical blocks, modules and circuits described in connection with the present disclosure may be implemented or performed with a general purpose processor, an AI processor, a digital signal processor (DSP), an application specific integrated circuit (ASIC), a field programmable gate array (FPGA) or other programmable logic device (PLD), discrete gate or transistor logic, discrete hardware components, or any combination thereof designed to perform the functions described herein. A general-purpose processor may be a microprocessor, but in the alternative, the processor may be any commercially available processor, controller, microcontroller, or state machine. A processor may also be implemented as a combination of computing devices, e.g., a combination of a DSP and a microprocessor, a plurality of microprocessors, one or more microprocessors in conjunction with a DSP core, a SoC, a SiP, or any other such configuration.

As used herein, a phrase referring to “at least one of” a list of items refers to any combination of those items, including single members. As an example, “at least one of: a, b, or c” is intended to cover a, b, c, a-b, a-c, b-c, and a-b-c, as well as any combination with multiples of the same element (e.g., a-a, a-a-a, a-a-b, a-a-c, a-b-b, a-c-c, b-b, b-b-b, b-b-c, c-c, and c-c-c or any other ordering of a, b, and c).

As used herein, the term “determining” encompasses a wide variety of actions. For example, “determining” may include calculating, computing, processing, deriving, investigating, looking up (e.g., looking up in a table, a database or another data structure), ascertaining and the like. Also, “determining” may include receiving (e.g., receiving information), accessing (e.g., accessing data in a memory) and the like. Also, “determining” may include resolving, selecting, choosing, establishing and the like.

As used herein, “coupled to” and “coupled with” generally encompass direct coupling and indirect coupling (e.g., including intermediary coupled aspects) unless stated otherwise. For example, stating that a processor is coupled to a memory allows for a direct coupling or a coupling via an intermediary aspect, such as a bus.

The methods disclosed herein comprise one or more actions for achieving the methods. The method actions may be interchanged with one another without departing from the scope of the claims. In other words, unless a specific order of actions is specified, the order and/or use of specific actions may be modified without departing from the scope of the claims. Further, the various operations of methods described above may be performed by any suitable means capable of performing the corresponding functions. The means may include various hardware and/or software component(s) and/or module(s), including, but not limited to a circuit, an ASIC, or processor.

The following claims are not intended to be limited to the aspects shown herein, but are to be accorded the full scope consistent with the language of the claims. Reference to an element in the singular is not intended to mean only one unless specifically so stated, but rather “one or more.” The subsequent use of a definite article (e.g., “the” or “said”) with an element (e.g., “the processor”) is not intended to invoke a singular meaning (e.g., “only one”) on the element unless otherwise specifically stated. For example, reference to an element (e.g., “a processor,” “the processor,” etc.), unless otherwise specifically stated, should be understood to refer to one or more elements (e.g., “one or more processors,” or the like). The terms “set” and “group” are intended to include one or more elements, and may be used interchangeably with “one or more.” Where reference is made to one or more elements performing functions (e.g., steps of a method), one element may perform all functions, or more than one element may collectively perform the functions. When more than one element collectively performs the functions, each function need not be performed by each of those elements (e.g., different functions may be performed by different elements) and/or each function need not be performed in whole by only one element (e.g., different elements may perform different sub-functions of a function). Similarly, where reference is made to one or more elements configured to cause another element (e.g., an apparatus) to perform functions, one element may be configured to cause the other element to perform all functions, or more than one element may collectively be configured to cause the other element to perform the functions. Unless specifically stated otherwise, the term “some” refers to one or more. All structural and functional equivalents to the elements of the various aspects described throughout this disclosure that are known or later come to be known to those of ordinary skill in the art are intended to be encompassed by the claims. Moreover, nothing disclosed herein is intended to be dedicated to the public regardless of whether such disclosure is explicitly recited in the claims.

What is claimed is:

1. An apparatus for wireless communications, comprising a processing system that includes one or more processors and one or more memories coupled with the one or more processors, the processing system configured to cause a user equipment (UE) to:
obtain, from a network entity, a first message that indicates a location corresponding to a codebook available for download; and
communicate with the network entity based on the codebook.

2. The apparatus of claim 1, wherein the processing system is configured to cause the UE to send, to the network entity, an indication that the codebook has been downloaded according to the location indicated in the first message.

3. The apparatus of claim 1, wherein the processing system is configured to cause the UE to send, to the network entity, a request to switch to the codebook for communications with the network entity.

4. The apparatus of claim 3, wherein the processing system is configured to cause the UE to communicate with the network entity based on a preconfigured codebook prior to communications with the network entity based on the codebook, wherein the request to switch to the codebook is sent based on communicating with the network entity based on the preconfigured codebook.

5. The apparatus of claim 1, wherein the processing system is configured to cause the UE to obtain, from the network entity, a second message that indicates to use the codebook for communications with the network entity.

6. The apparatus of claim 5, wherein the processing system is configured to cause the UE to establish a communication link with the network entity, wherein the second message is obtained based on the communication link being established.

7. The apparatus of claim 5, wherein the second message comprises a radio resource control (RRC) message.

8. The apparatus of claim 1, wherein the processing system is configured to cause the UE to send, to the network entity, channel state feedback based on the codebook.

9. The apparatus of claim 8, wherein:
the codebook comprises a plurality of precoders of different ranks and associated modulation and coding schemes (MCSs), and
the channel state feedback comprises an indication of a rank and a precoder selected from the plurality of precoders and an associated MCS to be used with the selected precoder.

10. The apparatus of claim 9, wherein to communicate with the network entity, the processing system is configured to cause the UE to communicate with the network entity based on the selected precoder and a combiner that corresponds to the selected precoder.

11. The apparatus of claim 8, wherein the channel state feedback comprises one or more of: a precoding matrix indicator (PMI), a rank indicator (RI), or a channel quality indicator (CQI).

12. The apparatus of claim 1, wherein:
the location corresponding to the codebook available for download comprises a public database that stores one or more codebooks, and
the one or more codebooks comprise the codebook.

13. The apparatus of claim 12, wherein:
the codebook comprises a plurality of precoders, and
the public database stores indications of mechanisms for transmission of channel state feedback for each precoder of the plurality of precoders.

14. The apparatus of claim 1, wherein the codebook is configured based on deployment parameters that are specific for communications with the network entity.

15. The apparatus of claim 1, wherein to obtain the first message, the processing system is configured to cause the UE to obtain the first message in a broadcast during an initial cell acquisition phase.

16. The apparatus of claim 1, wherein to obtain the first message, the processing system is configured to cause the UE to obtain the first message based on a capability of the UE to support usage of the codebook available for download.

17. An apparatus for wireless communications, comprising a processing system that includes one or more processors and one or more memories coupled with the one or more processors, the processing system configured to cause a network entity to:
send, to a user equipment (UE), a first message that indicates a location corresponding to a codebook available for download; and
communicate with the UE based on the codebook.

18. The apparatus of claim 17, wherein the processing system is configured to cause the network entity to obtain, from the UE, an indication that the codebook has been downloaded according to the location indicated in the first message.

19. The apparatus of claim 17, wherein the processing system is configured to cause the network entity to obtain, from the UE, a request to switch to the codebook for communications with the UE.

20. A method for wireless communications by a user equipment (UE) comprising:
obtaining, from a network entity, a first message that indicates a location corresponding to a codebook available for download; and
communicating with the network entity based on the codebook.
